(19) United States
(12) Patent Application Publication
(10) Pub. No.: US 2016/0098941 A1
(43) Pub. Date: Apr. 7, 2016

(54) METHODS AND APPARATUS FOR GOALTENDING APPLICATIONS INCLUDING COLLECTING PERFORMANCE METRICS, VIDEO AND SENSOR ANALYSIS

(71) Applicant: DOUBLE BLUE SPORTS ANALYTICS, INC., Orono, ME (US)

(72) Inventor: Dani Michael KERLUKE, Hermon, ME (US)

(21) Appl. No.: 14/892,869

(22) PCT Filed: May 21, 2014
(86) PCT No.: PCT/US14/38909

§ 371 Date: Nov. 20, 2015

Related U.S. Application Data
(60) Provisional application No. 61/825,547, filed on May 21, 2013.

(51) Int. Cl. G09B 19/00; A63B 69/00

(52) U.S. Cl. CPC G09B 19/0038; A63B 69/0026

(57) ABSTRACT

Methods and apparatus for capture, processing, storage, retrieval and display of goaltending sports performance metrics, analytics, and video, comprising a portable computing device (20), with touch-input display (100), specially adapted to receive and process telemetry metrics from movement and position sensors and multiple-angle video devices (40). Inertial measurement sensors (10) attached to or embedded in goaltender equipment (2) and three-dimensional space sensors (30) arranged In the vicinity of a goal or net (3) create a digital environment for processing, analyzing, and translating goaltender performance metrics to Improved performance by goaltender testing, evaluation and comparison, and review of video and performance metrics during and after games and practices. Gesture-based user Interfaces and sensor-based automated video tagging expedite tagging video with contextualized metadata characterizing identified goaltending events. System (50) stores tagged video, performance metrics, analytics and summarized test scores to a remotely accessible Performance Library (55) for game, season, and career assessment.

### CROSS REFERENCE TO RELATED APPLICATIONS

This application claims benefit of priority of U.S. Provisional Patent Application 61/825,547 filed May 21, 2013, which is incorporated herein by reference.

### COPYRIGHT NOTICE

A portion of the disclosure of this patent document contains material subject to copyright protection. The copyright owner has no objection to the facsimile reproduction of the patent document or the patent disclosure, as it appears in the United States Patent and Trademark Office patent files or records, but otherwise reserves all copyright, whatsoever, and including any displays of data, arrangements and/or graphic representations of data, which may be disclosed as static or interactive user interface displays herein.

### FIELD OF THE INVENTION

The present invention relates generally to data collection and analysis in the field of sports, and specifically in the fields of sports to which goaltending is an associated activity. More particularly, the present invention relates to improved methods, systems, and apparatus for the capture, analysis, storage, retrieval and display of multiple angle video streams with associated goaltender activity data, performance metrics and analytics, using efficient gesture-based, contextualized touch-input interactive displays, and using automatic video tagging based on wearable movement and position sensor data for the analysis of goaltending performance during games, practices, and skill development testing.

### BACKGROUND OF THE INVENTION

Goaltending is a unique and highly specialized position in sports where the outcome of the game depends critically on the performance of the goaltender. To improve play at this critical position and to reach the highest levels of competition, goaltenders and their coaches, whether professional, amateur or youth, desire more data, metrics and analytics, with more immediate feedback for in-game and post-game performance analysis.

Assemblage of metrics and analytics on goaltender performance is vital to the development of the goaltender so that he or she, along with coaches and parents, can review, evaluate, and improve performance during a game, over a season, and throughout his or her goaltending career. Existing methods of collecting of goaltender performance data during a game typically require the focused attention of at least one coach or assistant. In one method, coaches or assistants manually record goaltender activity on paper “shot charts,” data which is later keyed into a computer program. The speed of goaltending sports, however, renders accurate and comprehensive recording of goaltender activity by manual methods nearly impossible, and provides none of the advantages of real-time in game or immediate post-game review. Effective use of manually recorded game data typically involves hours of tedious additional post-game data input.

Conventional video recording may capture video of goaltender performance during a game or practice, followed by manual review of video cued to goaltending related activities and events. Video cued to face-offs and puck handling, for example, or to events such as shots on goal, saves, and rebounds, provides an opportunity for coaches and their goalies to identify areas for further training and improvement. Known systems for recording video of sports activity may provide means to indicate, while recording, the time stamp of a goaltending event within video capturing goaltending activity. While such video “tagging” saves time in reviewing video of goaltending performance, coaches and assistants must review the video and input additional data associated with goaltending events into a computer program. Known video tagging systems provide only “flat tagging,” lack direct and immediate capture of data associated with goaltending events, and provide no means to accurately and automatically locate, capture, compile and display data, metrics and analytics from a rapid sequence of goaltender performance events over the course of a game. Thus, effective use of tagged video with conventional data recording still involves hours of post-game review of video and post-game input to fully capture the necessary data to provide comprehensive metrics and analytics on goaltender performance during games and practices.

Conventional video tagging also lacks means to directly and in real-time record data on goaltender events such as shot location, save location, and rebound trajectories, and provides no means to use advanced data filtering to select video segments associated with particular goaltending activity, for example, by type of event, by goalie identity, or by game, series or season. Outside of professional or well-funded college sports programs, few teams have the resources or personnel required to purchase and operate data systems to accumulate accurate and complete game and season data, and no present systems provide for real-time in game and or immediate post-game display and feedback to coaches, players, parents, scouts or spectators of the goalie's performance analysis, metrics, and statistics. Known video tagging and sports performance data systems further lack the ability to methodically test goaltender reactions against expert goaltender performance data, or to rate or compare current performance to past experience of the goaltender or to the performance of his or her peers.

Advances in technology of wearable, compact and self-contained wireless movement and position sensors, heretofore unapplied in the manner of the present invention, enables further advantages in the efficient and effective capture, collection, analysis, and display of goaltender performance video and data. Using advances in human kinetics measurement by applying advances in wireless inertial measurement unit (IMU) sensor technology to the field of goaltending enables automatic video tagging, which, when used in place of or in conjunction with gesture-based contextualized touch-sensitive user interfaces, as newly provided by the present invention, provides for efficient tagging of video of goaltender activity for automated real-time data collection for immediate use in game-time coaching analysis and decision-making. Using the combined movement and position sensor data in conjunction with advances in three-dimensional position (3D Space) sensors further enables goaltender performance metrics and analytics by comparison to previously captured goaltending performance data or similarly acquired expert performance data to further develop skills of the aspiring goaltender.

In summary, existing goaltender performance data collection and video review systems are cumbersome, expensive, and difficult to use, and lack essential capabilities for efficient and effective goaltender feedback during games, practices, and testing activities. It is, therefore, desirable to provide improved methods, systems, and apparatus for the effective and efficient capture, analysis, storage, and display of video and performance data by novel systems, methods, and apparatus for assembling comprehensive goaltender performance metrics and analytics, for in game and immediate post-game analysis in game, practice, and goaltender testing environments.

Other objectives of the present invention will be readily apparent from the summary and detailed description to follow.

### SUMMARY OF THE INVENTION

In general, the present invention is a mobile, portable, or desktop computer application that collects and analyzes goaltender performance metrics using wireless inertial measurement units (IMUs), wireless three-dimensional space (3D Space) sensors, and multiple-angle video streams for tagging goaltender events with contextualized data during games, practices, and testing activities. New technologies and methods as applied by the present invention overcome present disadvantages of expensive and cumbersome sports performance data capture and video review systems, and encourage ongoing assemblage and use of performance data, metrics and analytics from games and practices, over complete seasons, for the comprehensive analysis, testing, and improvement of this critical position in goaltender related sports. Movement and position sensors and video data create a digital environment in which to process, analyze, and translate specific goaltender performance metrics to improved performance through goaltender testing and by review of video, metrics and analytics during and after dames and practices.

In particular, the present invention provides improved methods, systems, and apparatus for comprehensive and efficient capture, analysis, storage, and display of tagged video using wearable movement and position sensor technology in conjunction with gesture-based interactive touch-input devices and user interfaces for assembling goaltender performance data, metrics and analytics for real-time in game and immediate post-game coaching and review using a local or remotely accessible performance library system. The present invention may further collect, store, retrieve, process, and export multiple-angle gesture-tagged video sequences with performance data for a goaltender to receive performance metrics and summarized test scores, which the goaltender may compare and share with other goaltenders using, or who have previously used, the system.

Automated video tagging as disclosed herein simplifies and expedites real-time data acquisition during games, practices, and testing, significantly aiding coaching staffs with actionable data to make informed decisions for goalie development. Improved methods also provide coaches, scouts, agents and the media means to analyze, assess, and report on the performance of goalies. The tagged video and event/meta data and analytics may be aggregated, stored, and transmitted to a cloud-based event performance data storage system for display on personal display devices to provide in game, post-game and seasonal analysis to coaches, scouts, agents, spectators, and the media, to analyze, assess, and report on the performance of both current and prospective goalies. As such, the present invention provides a unique three-dimensional telemetry collection system enabling 360° degree spatial analysis of performance metrics and analytics for goaltenders, coaches, parents, and scouts to evaluate and improve the athletic performance of goaltenders in goaltending related sports contests, camps, clinics and practices.

As will be readily apparent to one skilled in the art, the following summarizes various embodiments comprising one or more aspects, features, and benefits according to the inventive concepts of the present invention, without departing from the full scope of the present invention. While the present invention is described herein for the sport of ice hockey, it should be understood that the invention is applicable to any sport involving goaltending including, but not limited to, field hockey, soccer, and lacrosse, all of which may benefit from one or more embodiments of the present invention.

In a first embodiment, a system is provided for the collection, analysis, storage, retrieval, and display of goaltending performance data, metrics and analytics. Specifically, the system includes apparatus for processing goaltender performance data and metrics comprising one or more sensor devices arranged in the vicinity of a goal for measuring data selected from a telemetry metrics group including acceleration, power, speed, rotation, goaltender biometrics, body position, movement, and distance; a computing device for processing the data to calculate performance metrics and summarized goaltender performance scores; and at least one wireless communications device for transmitting and/or receiving the data the computing device. The system further includes a method and computer program product for measuring, at one or more sensor devices, data selected from a telemetry metrics group including acceleration, power, speed, rotation, goaltender biometrics, body position, movement, and distance; transmitting, wirelessly, telemetry metrics on acceleration, power, speed, rotation, biometrics, body position, movement and distance; receiving the telemetry metrics; and processing the received telemetry metrics to calculate performance metrics and summarized goaltender performance scores during a game, practice or goaltender testing activity.

According one aspect, the system may comprise one or more sensor modules attached to the goaltender or goaltending equipment, or embedded in the goaltending equipment. Sensor modules may include inertial measurement unit sensors (IMUs) for providing information on goaltender movement and position. Sensor modules may acquire, store, receive and transmit sensor data including, but not limited to, acceleration, power, speed, rotation, body or body part position or orientation, absolute and relative position, movement and distance.

According to a second aspect, the system may comprise one or more sensor modules mounted to a goal or otherwise deployed in the area of a goaltender. Sensor modules may include three-dimensional space sensors (3D Space) for providing information on goaltender movement and position within and around the area of the goal. 3D Space sensors may acquire, store, and transmit information including, but not limited, goaltender or goaltender equipment position, orientation, and absolute or relative position, movement and distance.

According to a third aspect, the system may include one or more video devices for recording, storing or transmitting single or multiple-angle video stream data. Video devices may include cameras to provide discrete or continuous video data streams of the goaltender or in the area of the goaltender, goal or net. Video capture devices may record, store, transmit and display processed or unprocessed analog or digital video data in real-time to portable computing devices or to local or central storage via wireless or wired communications.

Advantageously, single or multiple-angle video data may be used to provide information on goaltender position, movement, and distance, absolute and in relation to the goal, net, rink, puck, or in relation to movement and position of team or opposing players,

According to a fourth aspect, the system may provide a portable computing touch-input device comprising a touch-sensitive input display area, a processor and memory to execute stored computer program instructions, and wired or wireless communications means for sending and receiving data. The portable computing device may display single or multiple-angle video data, and may use a gesture-based interface for display and input of contextualized data based on goaltender activities and events. Computer program instructions may provide processing of IMU and 3D Space sensor data, including, but not limited to processing for receiving, conditioning, filtering, storing, retrieving, analysis and display of sensor, video, and goaltender performance data, metrics, and analytics. Wired or wireless communications means may transmit and receive information and control data from video cameras and sensor modules, including, but not limited to, the IMU and 3D space sensor modules. Communications means may additionally store and retrieve sensor, video, and performance data to local or centralized or distributed “cloud” based data storage.

In a second embodiment, goaltending equipment apparatus may comprise one or more sensor modules attached to or embedded within one or more goalie pads, blockers, gloves, sticks, skates, helmets, and the like. Sensor modules may include inertial measurement unit sensors (IMUs) for providing information on goaltender movement and position. Sensor modules may acquire, store, receive and transmit sensor data and information including, but not limited to, acceleration, power, speed, rotation, body or body part position or orientation, absolute and relative position, movement and distance. Advantageously, sensor modules may communicate to provide information on the relative position(s) of one or more sensor-enabled goalie pads, blockers, gloves, sticks, skates, or between sensed body position or extremities and the like.

In a third embodiment, a method and apparatus is provided for the measuring, transmitting, receiving, storing, and processing of movement and position sensor module data, and additionally, receiving, storing, and display of tagged video data, and for calculating and displaying goaltender performance metrics and analytics, including summarized performance metrics and goal rankings.

In a first aspect, the method and apparatus may include measuring, at one or more sensor modules attached to the goaltender or goaltending equipment, or embedded within the goaltending equipment, data on goaltender movement and position including, but not limited to, acceleration, power,speed, rotation, body or body part position or orientation, absolute and relative position, movement and distance. The method may further include transmitting sensor module data from the one or more sensor modules, receiving sensor module data at a touch-input device or, alternatively, at a local or remote central computer, and processing the received data during a game, practice or testing mechanism to calculate and display performance metrics and summarized test scores.

In a second aspect, the method and apparatus may include tagging one or more video streams with goaltender event metadata using gestured-based touch-input contextualized displays to rapidly identify and attach metadata to one or more goaltender events. Advantageously, the method may include automatically tagging video streams using movement and position sensor data to detect, identify, and attach metadata to one or more goaltender events synchronized to real-time or stored sensor and video data.

In a fourth embodiment, a system is provided for the display and review of goaltender performance metrics and analytics from a locally or remotely accessible, performance library system. The performance library system may include comprehensive performance metrics, statistics and video of goaltender performance during games, season, and throughout goalie career development. Specifically, the system includes apparatus method for compiling and utilizing a Performance Library system of goaltending data, metrics, video data, and summarized performance scores comprising one or more sensor devices arranged in the vicinity of a goal for measuring telemetry data selected from a telemetry metrics group including acceleration, power, speed, rotation, goaltender body position, movement, and distance; a computing device for processing telemetry data to calculate performance metrics and summarized performance scores; a wireless transmitter for transmitting telemetry data wirelessly to the computing device; one or more video devices arranged in the vicinity of a goal for capturing video data selected from discrete movements of a goaltender; a computing device for associating video data with movements by way of a gesture-based tagging scheme to form tagged data streams; and a data storage device for storing tagged data streams, performance metrics, and summarized performances scores in a performance library for subsequent retrieval. The system may further include a method and computer program product for compiling and utilizing a Performance Library system of goaltending data, metrics, video data, and summarized performance scores, comprising measuring telemetry data selected from a telemetry metrics group including acceleration, power, speed, rotation, goaltender body position, movement, and distance; transmitting telemetry data wirelessly to a computing device; receiving telemetry data at the computing device; processing telemetry data to calculate performance metrics and output summarized performance scores; capturing video data selected from discrete movements of a goaltender; associating video data with discrete movements by way of a gesture-based tagging scheme to form tagged data streams; and storing tagged data streams, performance metrics, and summarized performance scores in a performance library for subsequent retrieval.

In a fifth embodiment, a system and method are provided for a testing environment for training and evaluation of specific goaltender skills.

In one aspect of the testing system, inertial measurement unit (IMU) sensor module and 3D Space sensor movement and position data may be processed by a testing algorithm during one or more specific goaltender tests or sequences of tests. The testing algorithm may receive, store, display, and analyze IMU and 3D Space sensor data including, but not limited to, acceleration, power, speed, rotation, body or body part position or orientation, absolute and relative position, movement and distance of the goaltender or goaltending equipment within and around the area of the goal or net.

In a second aspect of the testing system, a touch-input device and interactive user interface are provided for selecting, instructing, executing and displaying performance metrics from one or more specific goaltender tests or sequences of tests, and for reporting summarized “T-Scores” of goaltender test performance.

In another aspect of the testing system, the user may connect to, compare and share his or her summarized test performance results via social media or with other goaltenders' performance data and summarized test scores through the testing interface. Advantageously, goaltenders can compare current and stored performance against earlier performance data and compiled scores of peers, professional or virtual goaltenders using idealized, theoretical skill data.

Other embodiments, aspects and features of the present invention will become apparent to those of ordinary skill in the art upon review of the following detailed description of specific embodiments of the invention in conjunction with the accompanying figures and drawings.

### BRIEF DESCRIPTION OF THE DRAWINGS

Embodiments of the present invention will now be describe by way of example only, with reference to the attached Figures.

FIG. 1 is a perspective view of a typical ice hockey goaltending performance testing system environment, illustrating inertial measurement unit (IMU) sensor modules and 3D Space sensors attached to or embedded in goaltender equipment and net, and depicting telemetry of the IMU and three-dimensional space (3D Space) sensor data via wireless communications to a portable computing device, in accordance with one embodiment of the present invention.

FIG. 2 is an illustration of IMU sensor modules attached to or embedded in typical ice hockey goaltending equipment for providing telemetry data related to movement and position of the goaltender and goaltending equipment, in accordance with one embodiment of the present invention.

FIG. 3 is an overhead view showing example configurations and location of 3D Space sensors for various goaltending sports including ice hockey, soccer, field hockey and lacrosse, in accordance with alternative embodiments of the present invention.

FIG. 4 is a perspective view of a typical ice hockey goaltender performance system environment showing multiple-angle video devices for capturing video data during game or practice application, and further illustrating telemetry of IMU sensors module data, 3D Space sensor data, and video device data via wireless communications to a portable computing device, in accordance with an embodiment of the present invention.

FIG. 5 is shows an exemplary, integrated 360° Degree Goaltender Performance System depicting functional components and modules of the present invention as may be implemented and employed in whole or in part under various embodiments described herein, and applicable generally to the collecting, processing, storage and display of goaltending performance metrics and analytics with associated tagged video data.

FIG. 6 shows a block diagram of one embodiment of the system as gesture-based interactive multiple-angle Video Tagging apparatus, applicable to a variety of applications with various embodiments.

FIG. 7 shows a block diagram of a preferred embodiment of the system as gesture-based interactive multiple-angle Video Tagging apparatus, using IMU sensors for automatic video tagging, applicable to a variety of applications with various embodiments.

FIG. 8 shows a block diagram of one embodiment of the system as Performance Library apparatus for review of gesture-tagged video data and goaltender performance metrics and summarized performance data.

FIG. 9 shows a block diagram of one embodiment of the system as Tender Testing System apparatus applicable to an exemplary method of testing goalie performance using telemetry metrics from inertial measurement unit and other sensor devices.

FIG. 10 shows a generalized flowchart for gesture-based methods of interaction with touch-sensitive gesture-based user interfaces, as applicable to a variety of applications and embodiments of the present invention.

FIGS. 11, 12 & 13 illustrate an exemplary method for video tagging using contextualized displays with gesture-based user interfaces to tag and time stamp captured video sequences of goaltending events, according to embodiments of the present invention.

FIGS. 14, 15 & 16 illustrate a preferred method of recording Saves according to an exemplary process and touch-input user interfaces, using automatic recognition of goaltending activity and tagging of video sequences based on 1MU telemetry metrics.

FIGS. 17 & 18 illustrate a preferred method of recording Goals according to an exemplary process and touch-input user interfaces with automatic tagging of video sequences exemplifying a process for the application to automatically tag video sequences using IMU based sensors applicable to a variety of applications with various embodiments.

FIG. 19 illustrates a preferred method of accessing previously stored and/or tagged video of goaltending events according to an exemplary process using touch-input user interface(s) to review and edit previously or partially tagged video data, applicable to a variety of applications with various embodiments.

FIGS. 20 & 21 illustrates an exemplary method of reviewing Goals by Location in the Performance Library using gesture-based identifiers and contextualized displays in accordance with one embodiment of the present invention.

FIGS. 22 & 23 illustrates an exemplary method of reviewing Rebound Goals by Location in the Performance Library using gesture-based identifiers and contextualized displays in accordance with one embodiment of the present invention.

FIGS. 24 & 25 illustrates an exemplary method of reviewing Saves by Location in the Performance Library using gesture-based identifiers and contextualized displays in accordance with one embodiment of the present invention.

FIGS. 26 & 27 illustrates an exemplary method of reviewing, summarizing and ranking Goals by Rank in the Performance Library using gesture-based identifiers and contextualized displays in accordance with one embodiment of the present invention.

FIGS. 28, 29, 30 & 31 illustrate an exemplary method of goaltender testing according to one embodiment of the present invention.

### DETAILED DESCRIPTION

Generally, the present invention provides a unique three-dimensional telemetry collection system enabling 360° degree spatial analysis of performance metrics for the goaltender or coaches or others to evaluate athletic performance of the goaltender in sporting events, training or testing activities, including sporting contests, camps, clinics and practices.

With regard to the accompanying figures and detailed description to follow, it is readily apparent that the present invention provides for a portable computing device to acquire, collect, process, export and record goaltending performance metrics data, gesture-based tagged multiple-angle video and statistics during games, in practice sessions, and skill testing activities, and to publish and review such data using a local or remotely accessible performance library system. While the present invention is described herein for the sport of ice hockey, it should be understood that the invention is applicable to any sport involving goaltending, including, but not limited to, field hockey, soccer, and lacrosse, all of which may benefit from aspects and features of one or more embodiments of the present invention.

For the purposes of the present invention, video tagging means the identification in time and the characterization by metadata of discrete or continuous events occurring within video captured from one or more multiple angle video capture devices. Video tagging is the process of identifying an event or activity within unprocessed video streams received from one or more real-time video devices or stored video data streams, and “tagging” the event as a discrete point in time (i.e. a “time stamp”) as a sequence of video with a fixed or variable duration. Tagging may involve recording the time stamp and/or durational time data of the goaltending event or activity, or additionally further processing the video stream to modify, extract, clip, or store a portion only of the video data. For each tagged event or activity, additional data (“metadata”) may be associated with the video at the time stamp or time duration to further characterize the event or activity with metadata, for storage and later retrieval together with the tagged video.

For the present invention, automated video tagging, uses touch-input devices with gesture-based user interfaces to identify goaltending activity and to capture metadata on identified goaltending events in synchronization with video captured from one or more video devices. Automatic video tagging means using movement and position sensors to automatically identify and characterize with metadata the specific goaltending activity identified without user input or intervention, automatically capturing and storing the video and metadata on the identified goaltending events. Automatic video tagging may partially or fully employ gesture-based automated video tagging and metadata capture and association by user input to expedite the identification and characterization of multiple events and associated multiple metadata points, during sporting events, sports training and testing activities, all without departing from the scope of the invention in either “automated” or “automatic” modes.

### Goaltender Performance System Environment

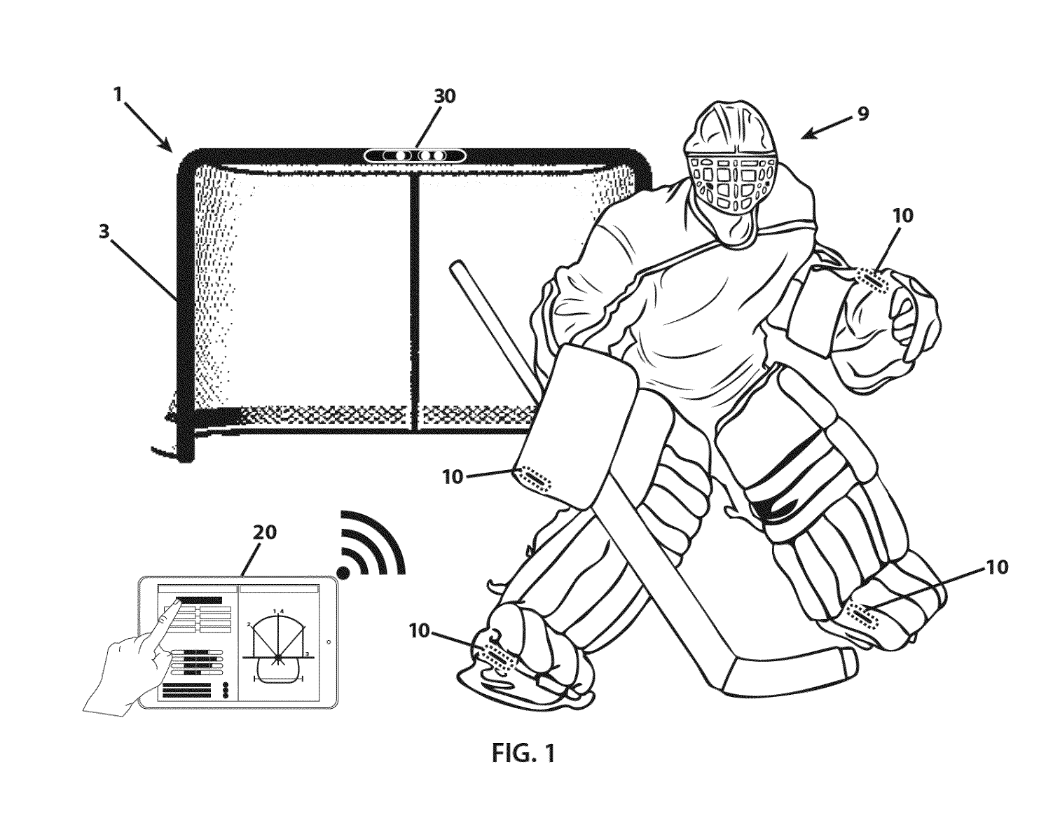

FIG. 1 shows a perspective view of a typical ice hockey goaltending performance system environment 1 in accordance with one embodiment of the present invention. As shown for the sport of ice hockey, the goaltending environment includes a goaltender 9 positioned in the vicinity of a goal or net 3, the goaltender positioned typically at the front of the net. In a game, practice, or testing activity, the goaltender may remain positioned in front of the net, or may temporarily leave the area of the goal or net for puck handling or other goaltender activity. The ice hockey goaltender 9 in FIG. 1 is shown outfitted with standard protective equipment including various pads, blockers, skates, chest and shoulder protectors, helmet (including facemask), goalie stick, and gloves; however, other equipment not specifically shown may be worn or arranged on the goaltender, and other goal structures or configurations may be substituted, as would be readily understood to one familiar with ice hockey, as well as other goaltending sports, without departing from the scope of the invention.

An exemplary system of the present invention for use in the goaltending environment of FIG. 1 may include a portable computing device 20 adapted for and configured to receive, transmit, store, process, display, and re-transmit goaltender data, metrics, analytics, or other performance data. Portable computing device 20 may be any computing device, capable of the features and functions attributed herein, including, but not limited to, tablet computers, smartphones, notebook, laptop, or desktop computers, mini-computing devices, TVs and set-top devices, thin or zero-client computer displays and terminals, or the like. It should be readily apparent from the aforementioned that the user of the present invention may be presented with a touch-sensitive interactive user interface that is either of a standalone type (e.g. a single computing device with local data storage and analysis) or an interactive type (e.g. a local computing “client” device interface connected to an Internet or cloud-based implementation or remote data storage). Moreover, interfaces of the standalone type may be used in conjunction with or without an interface of an interactive type.

Preferably, the portable computing device 20 comprises a touch-sensitive display device with interactive graphical user interface display area, which is programmatically adapted for and configured to sense, accept and process user input by direct or indirect gesture-based input. As depicted in FIG. 1, gestured-based touch-sensitive user input may receive a user indication by hand, or finger (single or multiple) motion or contact by touching or swiping the touch-sensitive area of the computing device, or by otherwise indicating user input selection or information by direct contact with the input device, or other bodily motion or indication in proximity thereto. Gesture-based user input may also include input by a pointing device such as a digital pen, mouse or mouse pad, by keyboard, or by video or voice recognition by any suitably capable input device. By way of example only, one such portable computing device with touch-sensitive user input capable of implementation of the functions of the present invention is the iPAD™ tablet computer by Apple™ of Cupertino, Calif. However, any suitable device running the Apple IOS™ operating system, or, alternatively, portable computing devices of the like including tablet computers running the Android™ operating system such the Samsung Galaxy Note™ by Samsung America, may be substituted without departing from the essence of the invention.

Further aspects, features, and benefits pertaining to the operation and configuration of the portable computing device and touch-sensitive input devices and interactive displays are discussed in detail below.

An exemplary embodiment of the present invention may include a goaltender outfitted with goalie equipment, as shown in FIG. 1, having one or more attached or embedded “wearable” sensor modules 10 for measuring movement and position and other metrics of the goaltender. For example, one or more inertial measurement unit (IMU) sensor modules 10 may sense and convert accelerometer, gyroscope, compass, and/or gravitational force data in three-directions to provide telemetry on acceleration, power, speed, rotation, absolute and relative orientation, movement and distance traveled. Sensor modules may additionally sense, filter, condition, store and/or transmit telemetry data by wireless protocol in real time to the portable computing device 20 or other local or remote computer via any suitable wireless or wired technology. IMU telemetry metrics on goaltender movement and position may be transmitted wirelessly in real-time to portable computing device 20 via any suitable wireless technology include Bluetooth, Wi-Fi, WPAN (Wireless Personal Area Network), UWB (Ultra Wideband) technology, or the like, or stored for later retrieval by various means including universal serial bus (USB) or removable storage. By way of example, wearable IMU sensor technology suitable for use in the present invention includes the Notch Device™ manufactured by Notch Devices, Inc. of Brooklyn, N.Y. However, it should be readily apparent to one skilled in the measurement and testing art that the IMU may be formed by any readily available measurement mechanism including, but not limited to, separate or integrated arrangements of accelerometers, gyroscopes, and magnetometers.

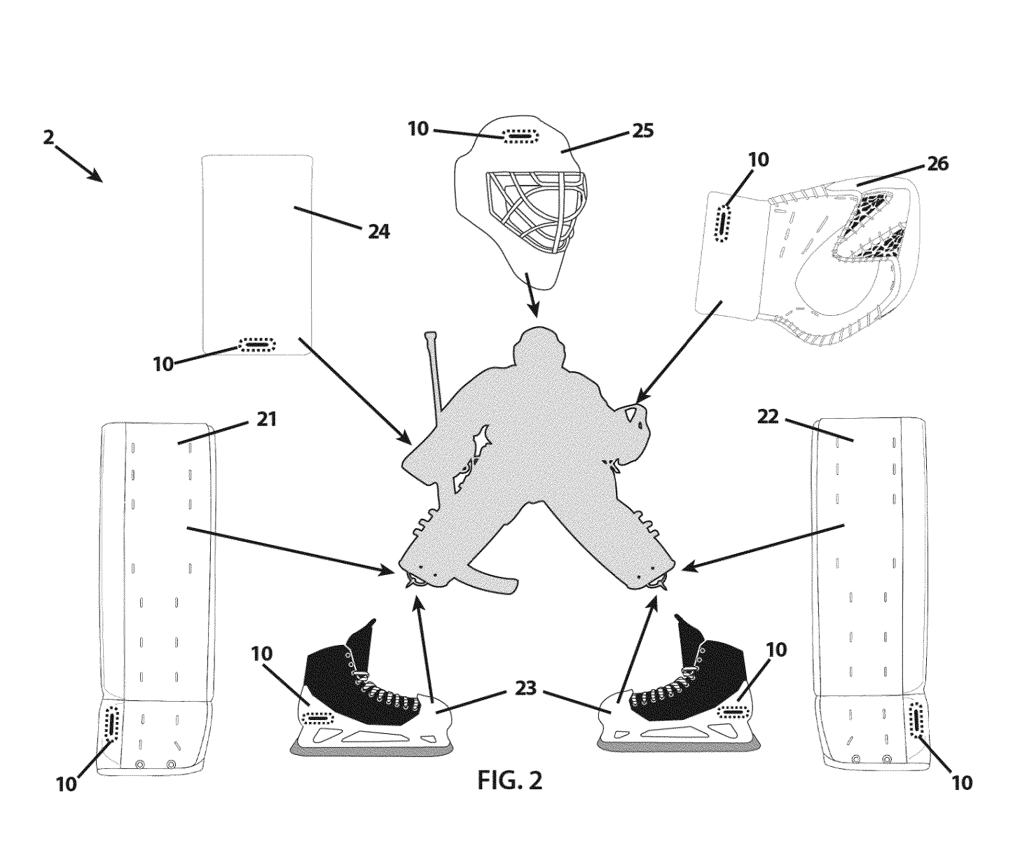

According to an embodiment shown in FIG. 2, goaltender equipment having wearable sensor modules may include inertial measurement unit (IMU) sensor modules 10 inserted into specially manufactured goaltender equipment to house and protect each sensor module, or otherwise provide encapsulation of sensors or sensor modules attached to an outer surface or section of one or more items of goaltender equipment. For example, FIG. 2 illustrates IMU sensor modules 10 attached to or embedded in typical ice hockey goalie equipment, including the left pad 21, right pad 22, skates 23, blocker 24, helmet 25, and glove 26. Sensor modules may also be attached to or embedded in other equipment not specifically shown in FIG. 1 or FIG 2 in any combination as appropriate for ice hockey or for other goaltending sports and their corresponding equivalent or additional equipment, as appropriate, without departing from the scope of the invention. A goaltender may wear any combination of goaltender equipment having attached or embedded sensor modules, or may wear goaltender equipment with no sensors.

For the purposes of the present invention, in reference to sensor devices attached to or embedded in goaltender equipment, “attached” means any manner of attaching or affixing one or more sensors or sensor modules to any surface, section, subsurface, flap, fold, lace, component or structure of an item of goaltender equipment. “Embedded” means inserting, during a manufacturing or post-manufacturing process, one or more sensors or sensor modules within the body of or integral to the structure or any component or subcomponent of any equipment worn by or associated with the goaltender. Equipment worn by the goaltender, according to any embodiment, may have one or more sensors attached or embedded in none, one, or multiple items of equipment without departing from the scope of the invention. Moreover, the IMU sensor modules utilized in the present invention may be formed as part of the goaltender's equipment and/or goal structure in any manner including, without limitation, being formed integrally with the goaltender's equipment and/or goal structure, or being formed separate from and additional to such equipment and/or structure.

Alternatively, or in addition to the configuration of IMU sensors modules 10 shown in FIG. 1 or FIG. 2, other types of sensors and sensor modules may also be attached, embedded, worn by affixing to or otherwise secured to the goaltender directly. Such other sensors may include biometric sensors (not shown) to measure heart rate, body temperature, and other biometric data associated with goaltender or general athletic activity. Biometric sensors and sensor modules may measure, filter, condition, store and/or transmit telemetry data by wireless protocol from one or more biometric sensor modules to the portable computing device 20. By way of example, one such biometric sensor device capable of providing telemetry data on biometrics as wearable biometric sensor modules is the Hexoscan Kit™ sold by Hexoscan Wearable Body Metrics, Ltd, of Montreal, QC.

Further aspects, features, and benefits pertaining to wearable sensor technology in the configuration and operation of the present invention will become apparent in the description to follow.

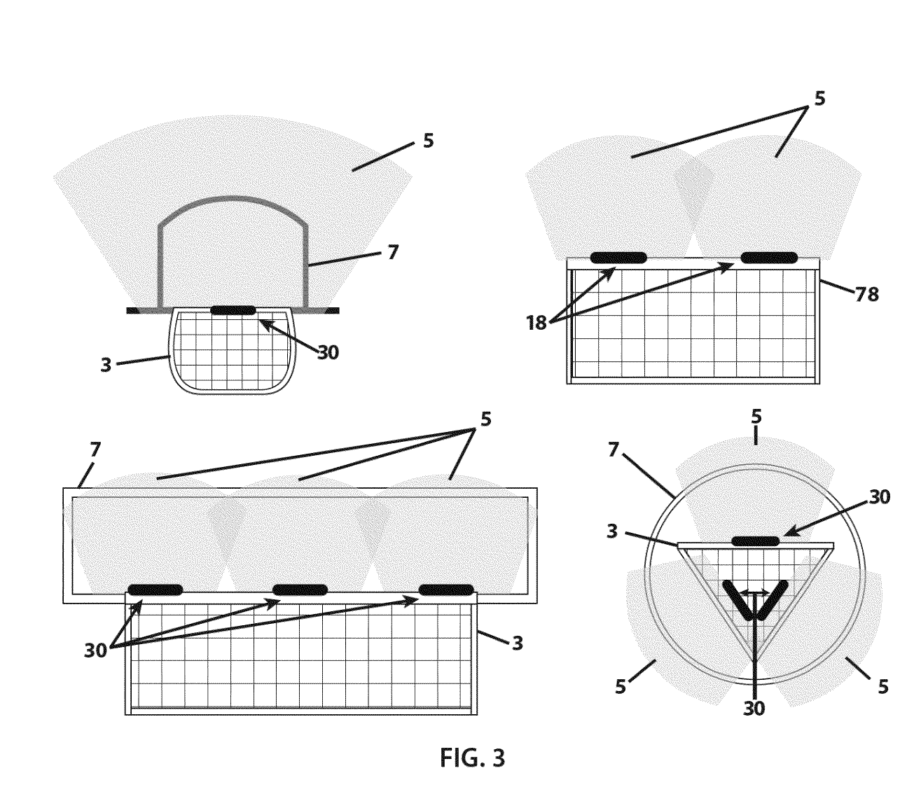

Returning to FIG. 1, the ice hockey goaltending performance system environment 1 may further include one or more three-dimensional space (3D Space) sensors 30. As shown in FIG. 1 3D Space sensors installed on or integral to the crossbar tube of the goal or net 3 may provide telemetry data on the movement and position of the goaltender within and around the goal. Alternatively, 3D Space sensors may be installed or mounted separately from the goal or net, for example, on or above the back wall of the ice hockey rink, behind the net, or directly above the goal or net in conjunction with goal monitoring/replay equipment. For other goaltending sports, 3D Space sensors may be positioned and mounted as appropriate to the particular location and configuration of the goal and structure(s) of or near the playing area of other sports. FIG. 3, for example illustrates overhead views of possible 3D Space sensor placements 30, for ice hockey 32, soccer 33, field hockey 34, and lacrosse 35, for each sport providing telemetry on movement and position of a goaltender in a defined region near the goal or net 3, in the zone 5, or (as in ice hockey) within a marked area known as the “crease” 7. While the placement of 3D Space sensors are shown in FIG. 3 in particular configurations and locations relative to the goaltender and goal structures of these sports, it should be readily apparent that any suitable placement that would facilitate data gathering from goaltender activity may be substituted according to the characteristics and limitations of any particular sport or sporting arena. Accordingly, no particular configuration shown or sensor placement in the drawings should be considered limiting to the present invention.

In a similar manner as the above mentioned IMU sensor modules providing movement and position wireless telemetry data by wearable sensor devices, 3D Space sensor telemetry data on goaltender movement and position may be transmitted wirelessly in real-time to portable computing device 20 via any suitable wireless technology include Bluetooth, Wi-Fi, WPAN (Wireless Personal Area Network), UWB (Ultra Wideband) technology, or the like, or stored for later retrieval by various means including universal serial bus (USB) or removable storage. By way of example, one such known device capable of providing telemetry data on three-dimensional movement and position of the goalie in the area of the goal or net is the iBeacon™ made by Apple, Inc. of Cupertino, Calif. However, it should be readily apparent to one of skill in the art that any such three-dimensional space detecting sensor technology may be substituted without departing from the scope of the invention.

Further aspects, features, and benefits pertaining to the 3D Space sensor in configuration and operation of embodiments of the present invention will become apparent in the description to follow.

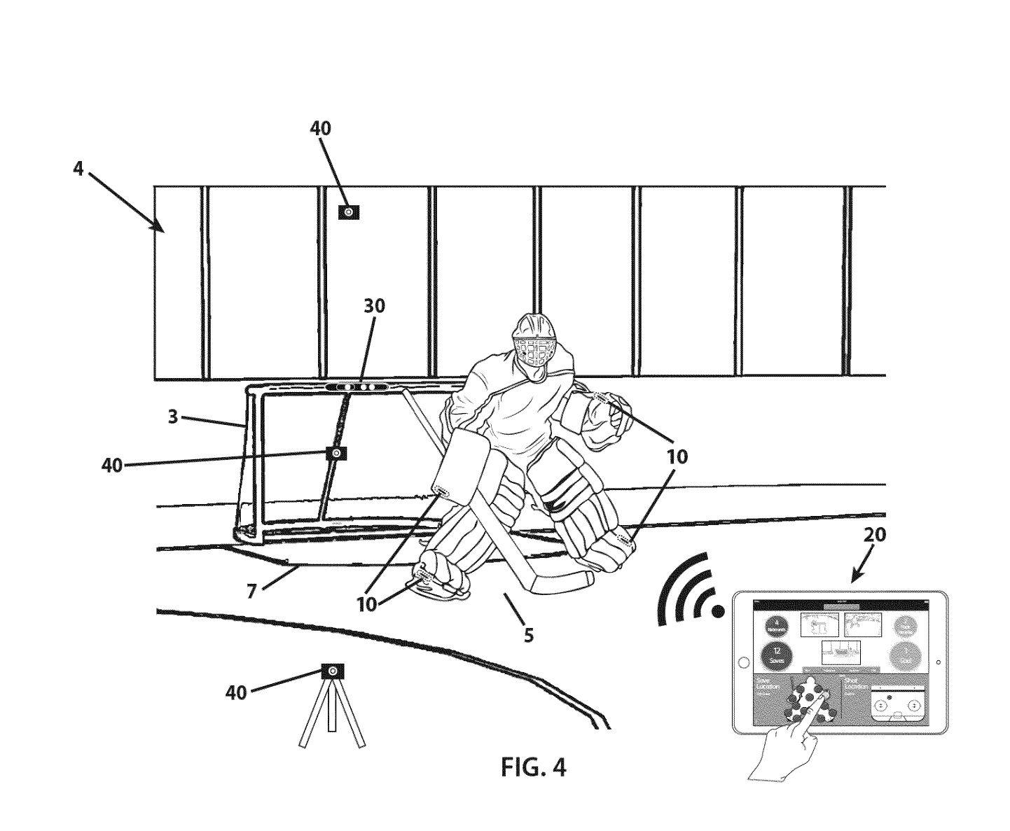

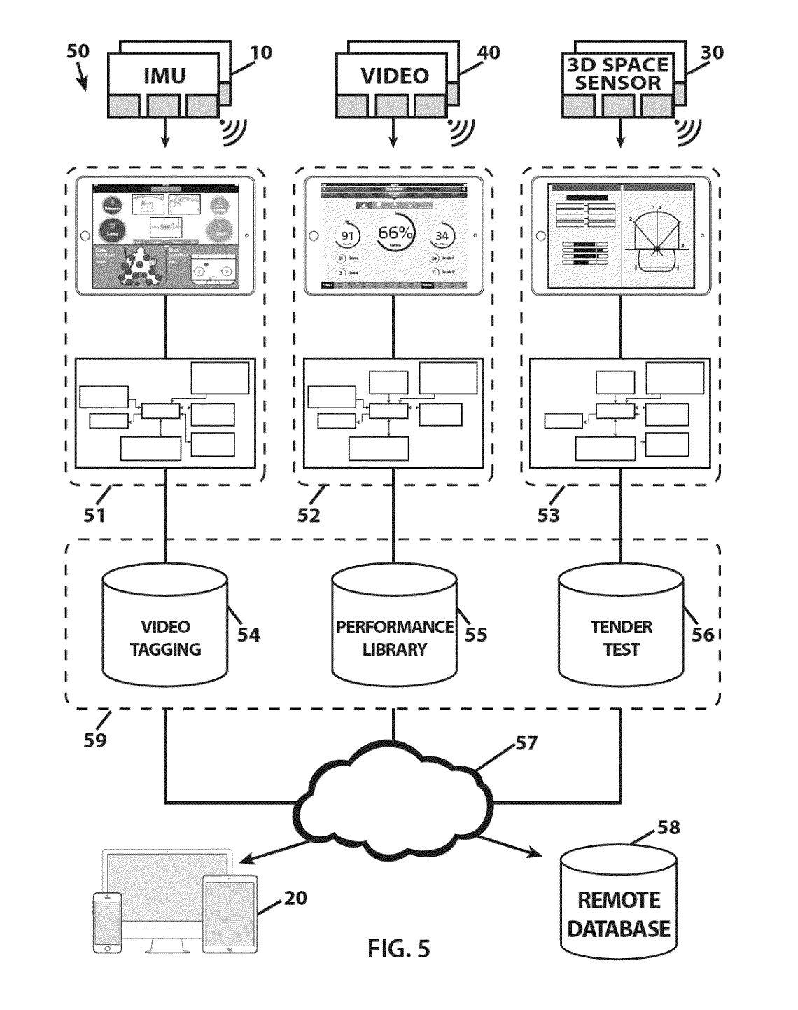

FIG. 4 illustrates a goaltender and goaltending performance system in a typical game or practice environment, according to one embodiment of the goaltender performance system, with goaltender 9, goal or net 3, on an ice rink 6 with rink enclosing wall 4. As shown in FIG. 4, an embodiment may include one or more video devices 40 positioned to capture and record video of goaltender activity in the vicinity of the net 3, crease 5 or zone 7. In one embodiment, video capture devices may be mounted on the rink enclosing wall 4, on or behind the net 3, or additionally or alternatively one or more video devices 40 may be mounted to other structures on or off the ice rink (not shown). Video may also be acquired from general video or TV recordings of the ice hockey game or practice activity.

Video devices as shown in FIG. 4, as adapted or configured for use with various embodiments of the present invention, may capture analog or digital video data in discrete or continuous streams, in single viewpoint or by multiple-angle video, and may further capture, store and/or transmit video data streams in real-time, or provide video data upon recovery from local storage devices such as SDRAM cards, micro SDRAM devices, hard drives or video tape storage, or from central storage devices having received and stored video for later retrieval. Portable computing device 20 may directly receive and present a portion of one or more unprocessed digital video streams in real time at the display, under viewing or editing control by interactive user interface, or by acquiring processed single or multiple-angle digital video data streams from digital video sources accessing local or remote storage devices via wireless or wired communications. Video devices preferably transmit in real time to the portable computing device 20 or other local or remote computer via any suitable wireless or wired technology, including Bluetooth, Wi-Fi, WPAN (Wireless Personal Area Network), UWB (Ultra Wideband), USB (universal serial bus), Ethernet, or the like, or to and from web-based or Internet or “cloud” storage by various communications protocols. By way of example, one such known digital video camera capable of implementation as a video device in the present invention is the Hero3Plus™ by GoPro, Inc. of San Mateo, Calif.

Further aspects, features, and benefits pertaining to the use of multiple-angle video cameras in the configuration and operation of the present invention will become apparent in the description to follow.

Having presented exemplar goaltending environments for application of the goaltender performance system, methods, and apparatus described herein, other aspects, features, functions, and capabilities of the present invention in accordance with and in use of the above mentioned portable computing device, touch-input device and user interfaces, wearable movement and biometric sensor technology, 3D Space sensors, and multiple-angle video devices, will become apparent in the description of embodiments and variations to follow.

### Goaltender Performance System

FIG. 5 illustrates systems and apparatus embodiments in an overall system view of one or more of the above described devices, functions, features, and capabilities of the present invention according to one or more applications of the 360° Degree Goaltender Performance System. Devices and modules for providing movement and position telemetry metrics and video data on goaltending events and activity, include inertial measurement unit (IMU) sensor modules 10, 3D Space sensors 30, and video capture devices 40. One or more of the sensors and video devices provide telemetry metrics or video data by wired or wireless communications, as shown, to each or several of the specific system embodiments 51, 52, and 53.

As depicted in FIG. 5, system embodiments Video Tagging 51, Performance Library 52, and Tender Test 53 include and/or are capable of employing one or more sensors and video devices by receiving telemetry metrics and video data, and by processing and displaying one or more contextualized graphical user interfaces to implement the features and functions described below. Databases Tagged Video 54, Performance Library 55, and Tender Test 56 in communication with one or more of the system embodiments may receive, store, retrieve, re-transmit and distribute goaltender performance data via a local network or over a network 57 using an Internet or cloud-based distributed remote data storage utility 58. Databases 54, 55, and 56 or portions thereof may be integral to the apparatus implementing the system embodiments, or may receive, store, retrieve and retransmit data to and from one or more Remote User Devices 59, providing access to the Performance Library, Tagged Video, and Tender Test databases by touch-input interactive user interfaces in a manner consistent with any of interfaces and computing devices described herein.

As further described below, with reference to the operation of the goaltender performance apparatus and methods of operation, the Video Tagging system embodiment 51 comprises a portable computing device with specially configured interactive touch-input user interfaces and an integrated system of components and modules for acquiring and tagging video data associated with goaltending events. Data associated with the Video Tagging embodiment may be stored in the Tagged Video database 54 or may be stored in combination with or distributed among the Performance Library, Tender Test, or Remote databases. The Performance library system embodiment 52 comprises a portable computing device with specially configured interactive touch-input user interfaces and an integrated system of components and modules for retrieving, analyzing, displaying and summarizing goaltending performance metrics and analytics acquired by the Video Tagging application 51. Data associated with the Performance Library embodiment may be stored in the Performance Library database 55 or may be stored in combination with or distributed among the Tagged Video, Tender Test, or Remote databases. The Tender Test system embodiment 53 comprises a portable computing device with specially configured interactive touch-input user interfaces and an integrated system of components and modules for testing goaltender performance using stored tests and comparison performance metrics. Data associated with goaltender testing may be stored in the Tender Test database 56, or may be stored in combination with or distributed among the Tagged Video, Performance Library, or Remote databases.

The systems, methods, and apparatus described herein for implementation of system embodiments 51, 52, and 53, and the 360° Degree Goaltender Performance System 50, as a whole, can be embodied as computer program product comprising computer readable instructions stored on tangible computer-readable media. Computer instructions may embody all or part of the functionality and those skilled in the art will appreciate that computer instructions can be written in one or more programming languages for use with a variety of computer architectures and operating systems, and that some embodiments may be implemented as a combination of software and hardware, or hardware only. Preferably, the systems, methods, and apparatus of the present invention described herein can be implemented in software written in a suitable language, such the X-Code Integrated Development Environment for Objective-C as implemented by Apple, Inc. of Cupertino, Calif., for execution on iOS™-based computing devices such as the iPhone™ or iPad™ and the like. However, the software and/or hardware performing the functions described herein can be implemented on any suitable device, running any suitable operating system, programmed by any suitable means, including devices and software implementations based on the Android™ operating system.

Data storage for databases 54, 55, 56, and 58 may be implemented by any number of unified or distributed databases using conventional database structures (e.g., relational, object-oriented, etc.) or other structures such as files and other data formats stored on web-based or disk-based device storage, flash or SD card memory, and the like. Data sources may include enterprise data systems or databases stored on web-based data services (e.g. the “cloud”) arranging information in any fashion in tables, files, hierarchical, relational or object-oriented data structures using indexes, stored queries, data files, log files, control files, or backup files as with conventional database systems. Internet or cloud-based databases may be provided by subscription-based services from third-party providers.

Without limitation, other combinations of devices, modules, features, functions and interfaces employed by or attributed to any one or several of the system embodiments may be implemented for application to other goaltending environments within the scope and capabilities of the present invention. While FIG. 5 depicts three example system embodiments of the 360° Degree Goaltender Performance System, it is readily apparent to one skilled in the art that other applications and embodiments comprising different combinations of one or more components, modules, functions, and user interface features as shown may be anticipated, according to the broad concepts and spirit of the present invention.

### Video Tagging Apparatus

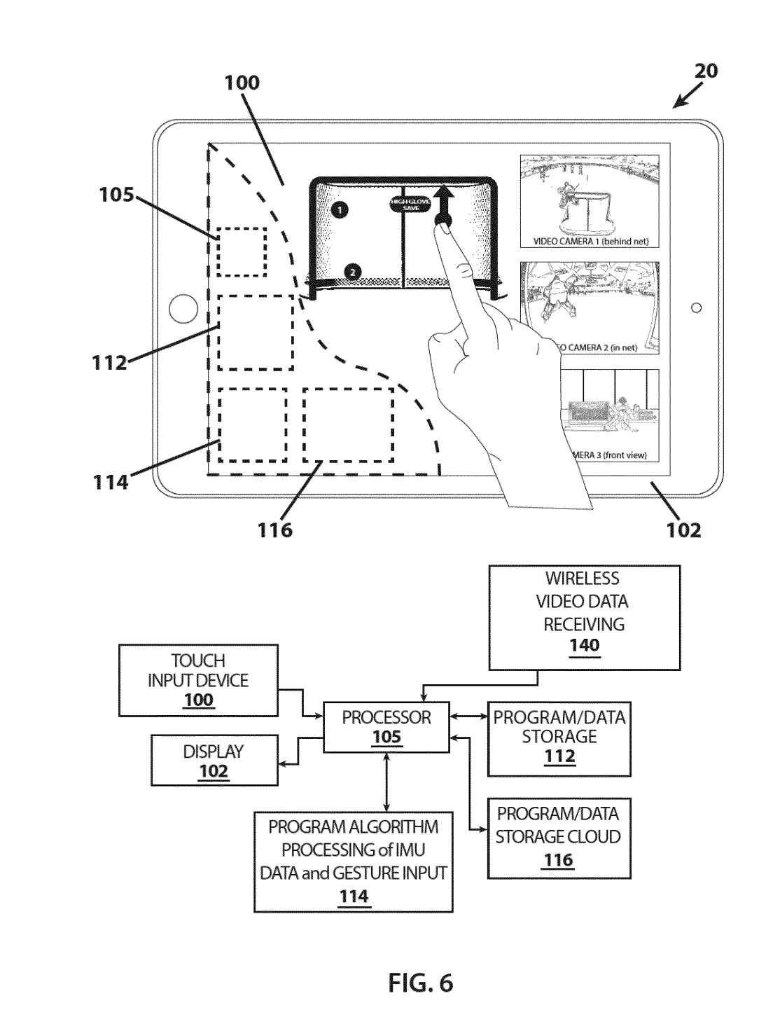

As shown in FIG. 6, the portable computer device 20 configured for the Video Tagging system embodiment comprises a touch-input device 100, display device 102, processor 105, program/data storage memory 112, and wireless video data communications module 140. In addition, Video Tagging apparatus may also include (not shown) communicating with IMU sensor modules and 3D Space sensors. It should be readily apparent that communications modules may transmit and receive video data, IMU and 3D Space data wirelessly via any other suitable wireless technology including Bluetooth, Wi-Fi, WPAN (Wireless Personal Area Network), UWB (Ultra Wideband). Alternatively or in addition to the above input, processing, storage, display, and communications modules, Video Tagging apparatus may comprise or be capable of accessing remote program/data storage 116, and provide computer program modules 114 for algorithmic processing of unprocessed or tagged video data, IMU sensor data, and/or 3D Space sensor data.

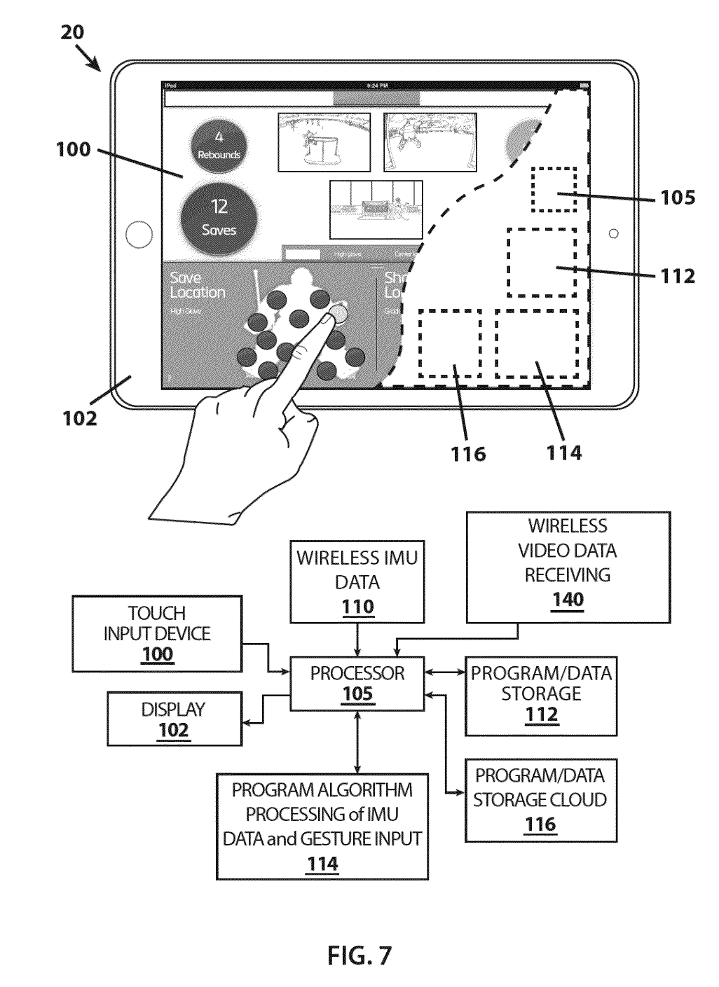

As shown in FIG. 7, in a second embodiment of the Video Tagging apparatus, the portable computer device 20 comprises a touch-input device 100, display device 102, processor 105, program/data storage memory 112, wireless IMU sensor communications module 110, and wireless video data communications module 140. In addition, Video Tagging apparatus may also include (not shown) communicating with 3D Space sensors. Video Tagging apparatus may comprise or be capable of accessing remote program/data storage 116, and provide computer program modules 114 for algorithmic processing of unprocessed or tagged video data, IMU sensor data, and/or 3D Space sensor data.

### Performance Library Apparatus

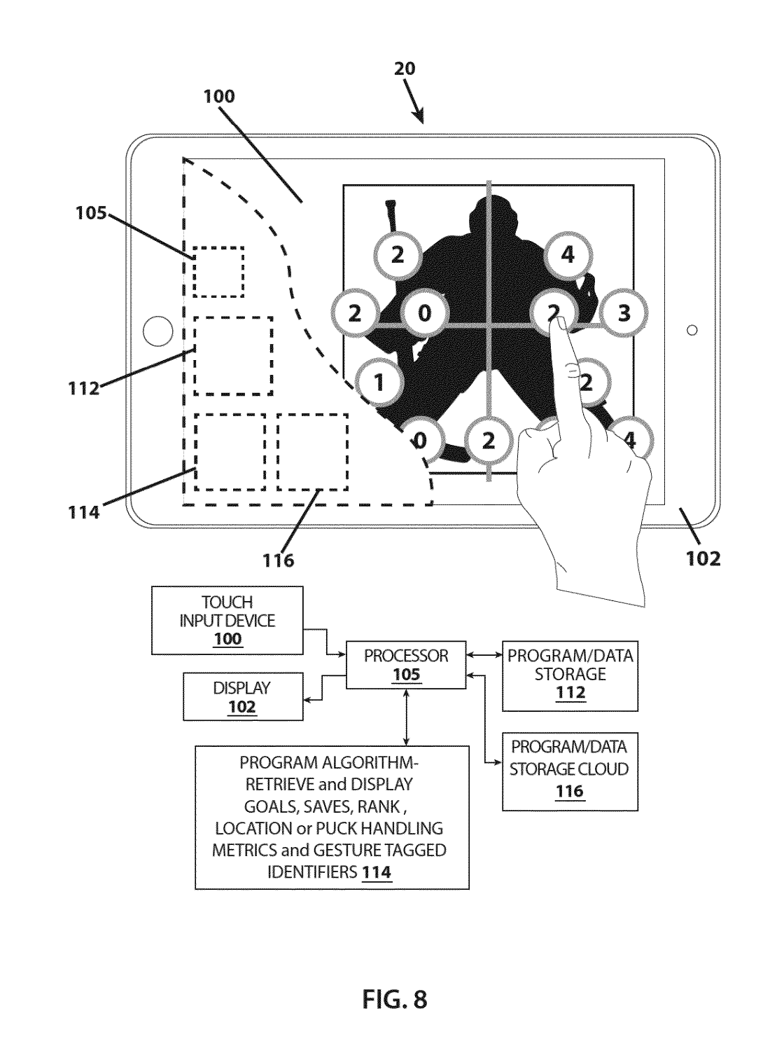

As shown in FIG. 8, the portable computer device 20 configured for the Performance Library system embodiment comprises a touch-input device 100, display device 102, processor 105, and program/data storage memory 112 Alternatively or in addition to the above input, processing, storage, display, and memory functions, Performance Library apparatus may further comprise or be capable of accessing remote program/data storage 116, and provide computer program modules 114 for algorithmic processing of movement and position data, tagged video metadata, performance metrics, analytics and summarized performance scores in the Performance Library database.

### Tender Test Apparatus

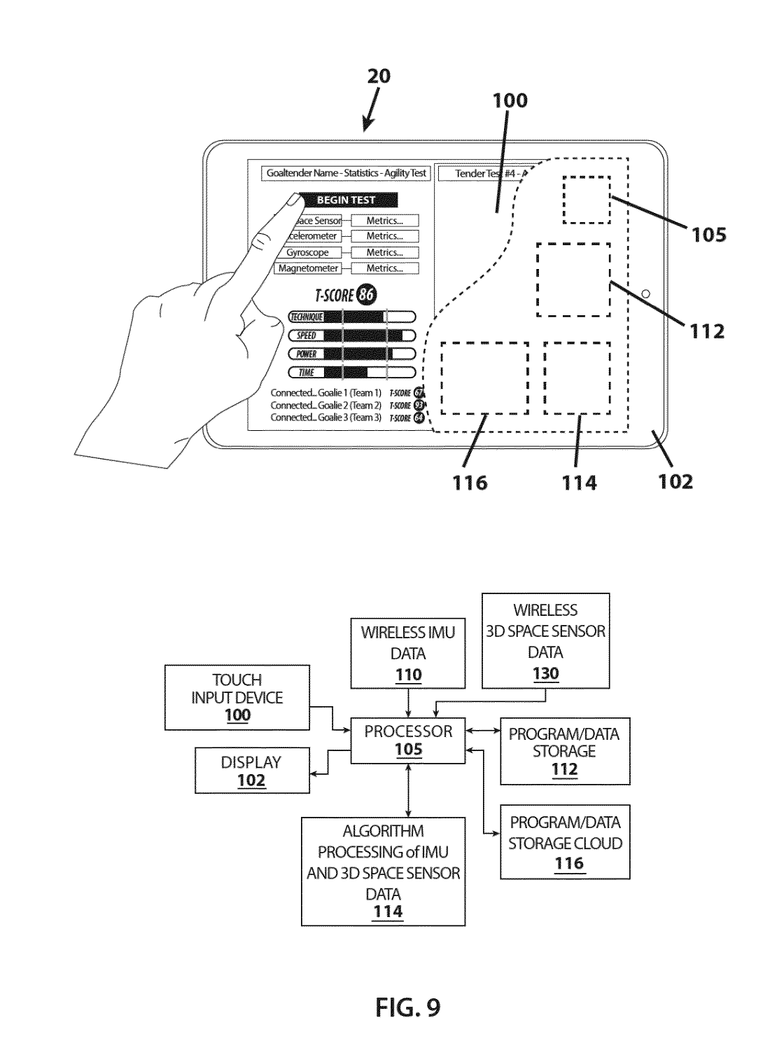

As shown in FIG. 9, the portable computer device 20 configured for the Tender Test system embodiment comprises a touch-input device 100, display device 102, processor 105, program/data storage memory 112, wireless IMU sensor module 110, and wireless 3D Space sensor communications module 130. In addition, Tender Test apparatus may also include (not shown) communicating with one or more video devices. Tender Test apparatus may further comprise or be capable of accessing remote program/data storage 116, and provide computer program modules 114 for algorithmic processing of IMU and 3D Space sensor data to perform goaltender testing using pre-configured, stored, or user selected test sequences.

### Gesture-Based User Interaction

Generally, the user interfaces shown in FIGS. 6, 7, 8, and 9, as with user interfaces to be introduced and described below, present portions of one or more video data streams, one or more movement or position sensor telemetry metrics, performance metrics and analytics, and other associated data in contextualized user interfaces capable of receiving user input by gesture on touch-sensitive regions of touch-sensitive input display. Upon receiving user input by touching, swiping, or otherwise gesturing to the input device, the gesture-based interface identifies the gesture and performs the users' intention accordingly.

Preferably, gestured-based user input receives a user indication by hand, or finger (single or multiple), by motioning, touching or swiping an activated area of the touch-input device (100) in an area indicated by the arrangement of data and graphics on the display (102). However, one or more areas may be activated for one or more distinct or related functions available to the user at any time. Generally, all or most areas of the contextualized user interface provide some means of interaction with the user, although not all areas may be activated at any time and at times no areas of the display may be activated for gestured-based input. Gesture-based user input may also include input by a pointing device such as a digital pen, mouse or mouse pad, by keyboard, or by video or voice recognition by any suitably capable input device. Without limitation, identified gestures include generalized gestures applicable to and recognized by the touch-input display of the portable computing device host apparatus or operating system.

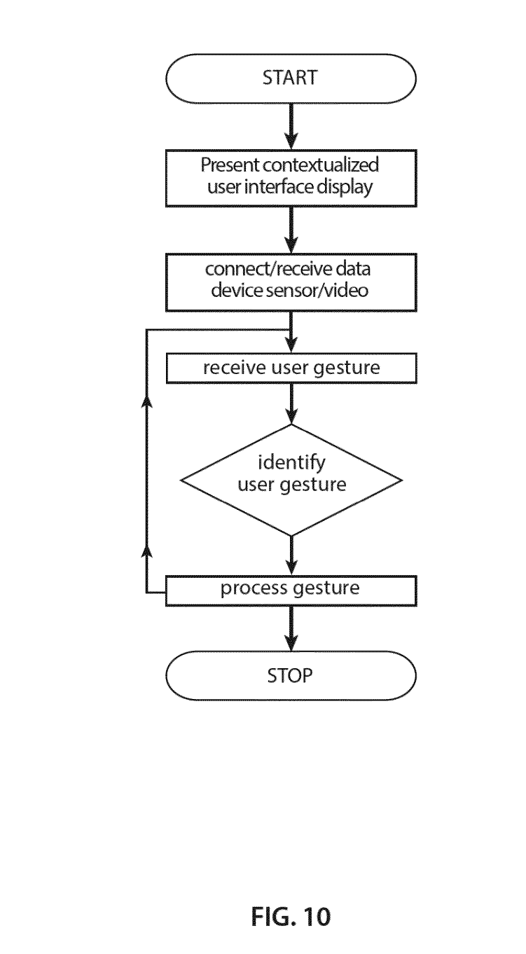

FIG. 10 illustrates the generalized method, summarized above, for receiving and processing gesture-based user input. To demonstrate aspects of the method, the Video Tagging apparatus of FIG. 7 is referenced by example of employing contextualized user interfaces to receive gesture-based user input for identifying and characterizing goaltending events as tagged video, thereby providing additional “metadata” associated with the tagged goaltending events. However, it should be understood that the method depicted in FIG. 10 is generally applicable to gesture-based user interactions for other applications and embodiments of the present invention herein described, and within the scope of the invention as more broadly applied and implemented.

First, in reference to FIG. 7, a contextualized user interface is presented on display 102 of the Video Tagging apparatus 20 for tagging goaltending activity as goaltending events occur in a games or practices. Next, wireless IMU communication module 110 and wireless video data communication module 140 connect available IMU sensors and video devices via wireless protocol to the apparatus. In the interface of FIG. 7, video data from three video devices is presented suggesting video of the goaltender activity from video devices positioned at three locations and directed toward the vicinity of the goal. Alternatively, one, two, or several video sources may be connected and displayed, or no video may be displayed if none is unavailable from any video device. Video data may also be received and displayed from stored video sources or database without loss of generality to the gesture-based methods described here.

Upon connecting, receiving and displaying video data, Video Tagging apparatus activates areas of the touch-input device 100 to receive gestured-based user input at appropriate times and to receive context-appropriate user input. Depending on context, and what user input or action is required and valid at the present moment or activity, one or more areas of the display may be activated for receiving and processing user gestures. Activated areas may be any shape, number, orientation or position within the touch-sensitive (or gesture-sensitive) region of the display or apparatus. As exemplified by FIG. 7, display 102 presents contextualized data with activated gesture input areas on touch-input device 100, including two circular areas labeled “Rebounds” and “Saves” and a goalie “Silhouette” at which the user, indicated by the “hand” graphic, is presently pointing.

In the specific context of FIG. 7, Video Tagging apparatus has already identified the specific goaltending activity, a “Save” as having occurred in the real-time goaltending activity as a “live” event or from a previously recorded game or practice. User input gestures identify a type of goaltending event (if sensor-based algorithms have not automatically done so), and contextualized detail displays are presented and activated to collect additional metadata on the “Save” event. In this context, the appropriate gesture-based user input is to receive a “Save Location” by indication on the touch-input activated circular areas of the goalie silhouette. In this example, the gesture indicated by the pointing finger on the goalie silhouette indicates a “Left Glove” save location.

It is noted that the present invention may include gesture-based user input other than the examples and modes depicted and described herein. For example, gestures may include any of one, two or more finger contacts with the touch-input device, gestures selected from a menu of gestures in which one more of the fingers are in contact, in motion or describing a path or trajectory about the touch-interface or portion thereof. Different gestures may mean different things in different contexts, and multiple areas may be simultaneously activated. In FIG. 7, for example, while the primary task in the “Save” context is for the user to indicate a “Save Location,” simultaneously activated circular areas “Rebound” and “Save” may readily accept a user indication of another rebound or save event occurring prior to or in lieu of Indicating a save location for the initial goaltending event. Video regions of the display may also be activated to receive user gestures to control pause and playback of video, for example, to review a video segment from an event just prior in real-time, or provided from stored video sources in review of prior game video.

Returning to the last step in FIG. 10, an identified gesture is processed to perform the Intention of the user. Intention of the user gesture Is Interpreted according to context and according to specialized gestures on activated areas of the contextualized interfaces. In the present example, the user's intention by touching the circular area on the glove of the goalie silhouette in the context of a “Save” indicates that the event should be tagged with metadata indicating “Left Glove” as the “Save Location,” and in the Video Tagging application, cause portions of the video containing the Save event to be tagged in time and associated with the “Save Location” event metadata.

Further aspects, features, and benefits of gesture-based input using contextualized user interfaces in the operation of the present invention will become apparent in the description to follow.

### Gesture-Based Video Tagging

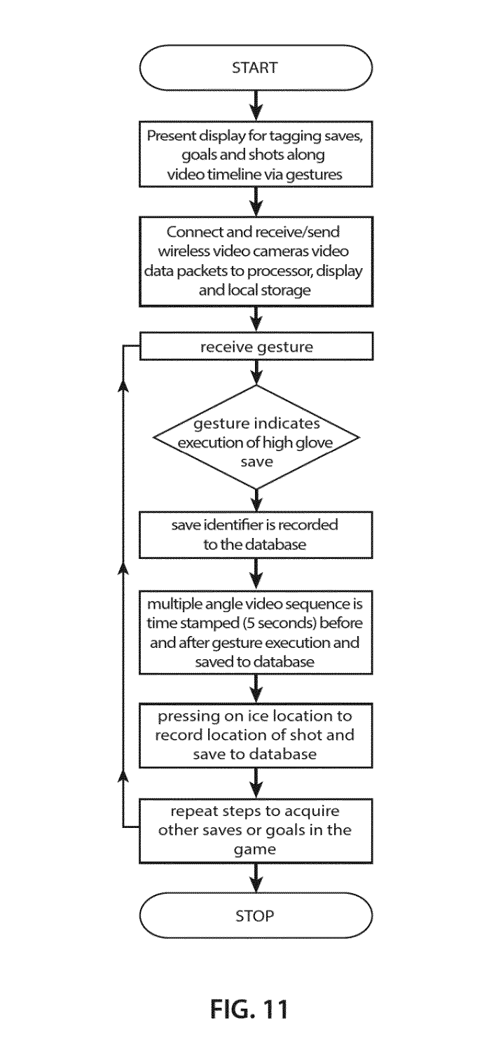

FIG. 11 illustrates a method of operation of the gestured-based video tagging apparatus of FIG. 6 to perform video tagging, according to some aspects of the present invention. FIG. 11 illustrates using contextualized display interfaces and receiving user input gestures selected from a menu of goaltending events for tagging saves, goals, and shots. To begin, a contextualized user interface is presented on display 102 of the portable computing device 20. Next, the apparatus connects via video data communication module 140 to available video devices, and initiates receive and display of video data to the video areas of display 102, as shown at the right within the user interface at the top of FIG. 11. Other data displayed on the user interface may include game information, game and season statistics, and summary data for shots, saves and goals, updated as goaltending events are tagged and recorded by the video tagging system.

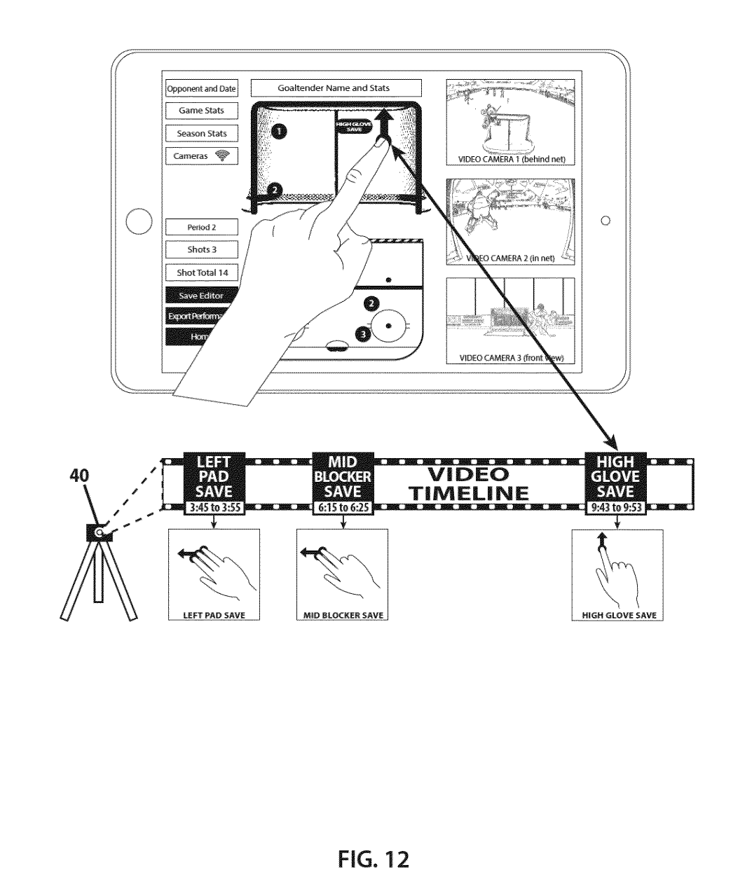

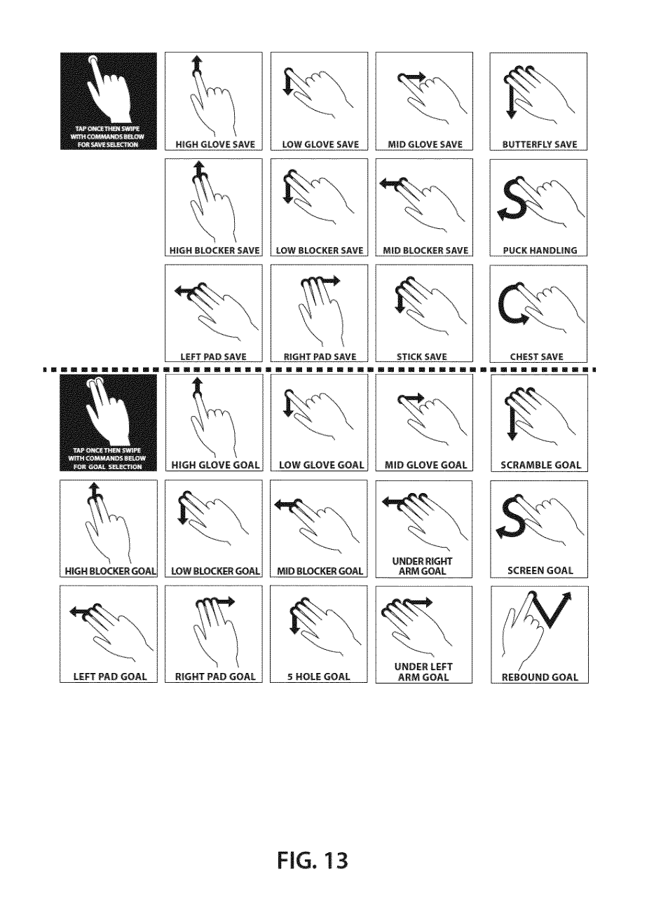

One or more areas of the touch-input device 100 may be activated for receiving user gestures associated with the goaltending events menu. As exemplified by the user interface in FIG. 11, display 102 presents an image of a hockey goal and net, and activates the touch-input device 100 to receive user gestures in the area of this image. For the gesture-based input embodiment represented by FIG. 11, gestures corresponding to goaltending events are selected by the user from a menu of gestures in which one more of the fingers are in contact, in motion or describing a path or trajectory about an activated region of the contextualized user interface. For example, a “Left Pad Save” is indicated by simultaneous, three-finger contact with the touch-input device in the region of the goal or net, with a coordinated motion or “swipe” to the left as shown in the box labeled “LEFT PAD SAVE” at the bottom of FIG. 11; a “MID BLOCKER SAVE” is indicated by two-finger contact with the activated region, with a swipe to the left as shown on the VIDEO TIMELINE of FIG. 11; a “HIGH GLOVE SAVE” is identified by a gesture of one-finger with an upward motion upon contact with the touch-input interface. The gesture menu shown in FIG. 12 provides a full set of gestures for indicating saves, goals, rebounds, and puck handling event, however, additional gestures of the like may be readily added to the gesture menu, without departing from the scope of this inventive method.

Upon indicating a goaltending event in the manner described above, the video tagging method proceeds to time stamping the video timeline at a discrete time or time interval spanning the goaltending event, and capturing the video data streams in recorded data of the Video Tagging database 54. Preferably, the time or time interval spanning the goaltending event is such that video stream data from five (5) seconds prior and five (5) seconds following the time of the user gesture ensures capture of the user identified goaltending event within the one or more video streams.

Time stamping of the video timeline and capture of the video stream data may be implemented in any suitable manner allowing storage, retrieval, and display of a discrete or continuous segment of the video stream to contain the indicated goaltending event. Such methods include recording a clipped segment of the video streams spanning the event as defined by starting and ending time stamps; recording the time or time interval of the event synchronized to a time reference stored or associated with the video data; storing synchronization data and video source identifiers sufficient to extract from the video source the segment of the video streams by modifying the unprocessed video streams at the video source with time stamp data and identifiers; or any other methods for time stamping and capturing video as would be understood by one of ordinary skill in the art such that the video data may be stored and recalled in synchronization with the identified goaltending event.

Continuing from the identification of the gesture and subsequent tagging of video as above, Video Tagging apparatus presents on the display a “shot chart” image of a hockey rink, and activates the touch-input device 100 to receive user gestures in the area of the shot chart. The user may then indicate on the shot chart a shot location associated with the save, goal, rebound, or puck handling event by touching the shot chart at an approximate location to indicate where the shot was taken. Additionally, a shot trajectory may be indicated on the shot chart by a gesture indicating a shot location and a rebound location, or by a user indication of the path followed by the puck from the shot location to the net, and, for a rebound event, along a rebound trajectory. Shot chart location data is stored as metadata in the video tagging database along with the goaltending event identifier and time stamps and captured video data, as above, fully identifying and characterizing the goaltending event for later review of video of individual events, and for processing performance metrics and analytics of single and cumulative events.

Repeating the steps above, the video tagging, gesture-based indications of associated metadata, and recording of time stamped and captured video with metadata in the Tagged Video database continues until the user or has tagged all events desired of the game, practice, or testing activity.

### Automatic Video Tagging

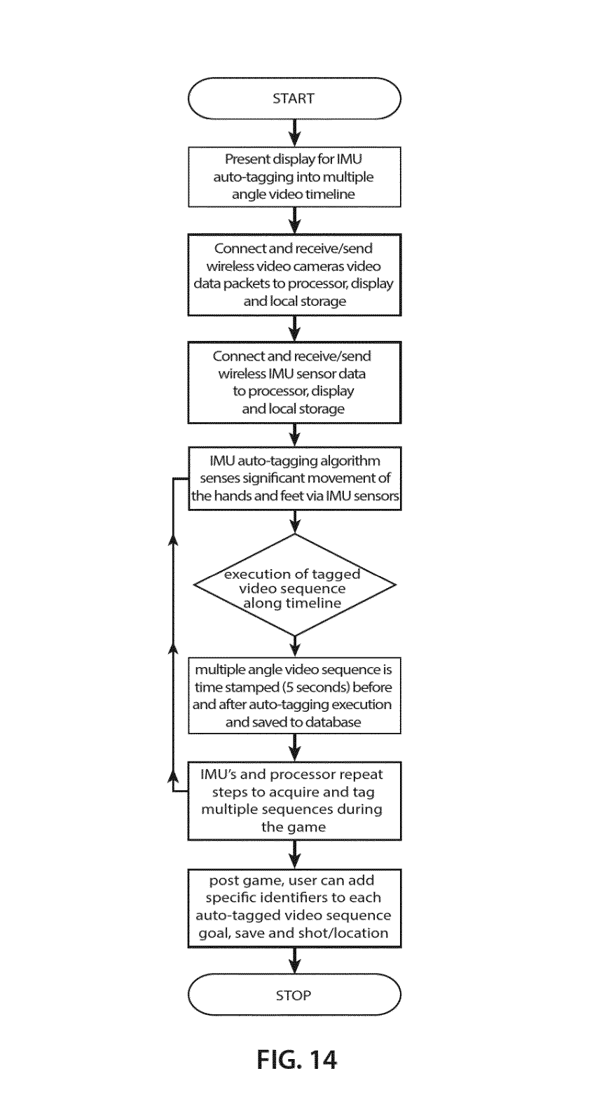

FIG. 14 illustrates a method of video tagging using video tackling apparatus and system embodiments as described above for FIG. 5 and FIG. 7. Having attached or embedding inertial measurement unit (IMU) sensor modules in goaltender protective equipment, as previously described with relation to FIG. 1 and FIG. 2, the telemetry metrics received by the apparatus from IMU sensor modules can be used to determine what goaltending event or technique, if any, the goaltender has initiated. Video tagging using inertial measurement unit (IMU) data may then automatically identify and tag goaltending events without the need for the user intervention for all or at least part of the video tagging operation. By processing telemetry data on acceleration, power, speed, rotation, orientation, or absolute and relative position, movement and distance of each embedded IMU sensor, the motion and position of the goaltender and relative position of the goaltender body parts in particular can provide a unique signature for identifying goaltender events. Particular movement and distance data from IMU sensor modules may then identify the specific type of goaltending event and thereby begin automatic tagging of the video with associated event data.

To begin, video tagging apparatus connects to video devices or sources of one or more video data streams from one or more multiple-angle video cameras 40. Next, the video tagging apparatus connects to receive telemetry data from one or more IMU sensor modules 10. Additionally, apparatus can connect to available 3D Space sensors 30 to receive telemetry data on the position of the goaltender within the crease or zone, providing further information to determine the type of goaltender event underway.

Upon sensing movement in the telemetry data received from IMU sensor modules and 3D Space sensors, if any, processing of the sensor data may indicate that a goaltending event has occurred. For example, the relative position and motion of a goaltender's left and right skates or pads is an indication that the goaltender is in or has moved to the “Butterfly. Save” position. The proper execution of the Butterfly Save in game and practice scenarios requires the goaltender's feet at a certain distance apart to maximize the coverage of the net with the pads. Too little distance and the goaltender's pads are not covering enough of the net too wide a distance between skates or pads, and the goaltender has limited mobility to recover for another save.

Therefore, for sufficiently trained goaltenders, the distance between skates as measured is a reliable indicator that can be used to determine that the goaltender has executed a butterfly save. In similar manner, using the full range of telemetry data, goaltending event types Save, Goal, Rebound, and Puck Handling may be uniquely recognized to initiate the tagging of video sequences for these events along the video timeline. As with gestured-based tagging, the video streams are time stamped and captured with metadata associated with the goaltending event.

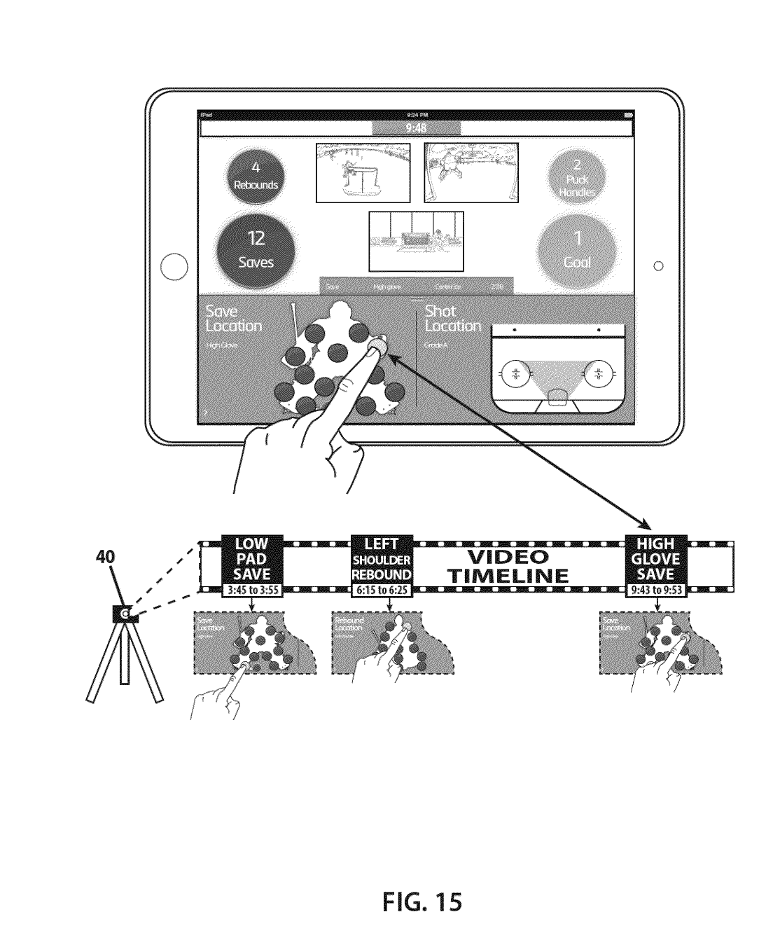

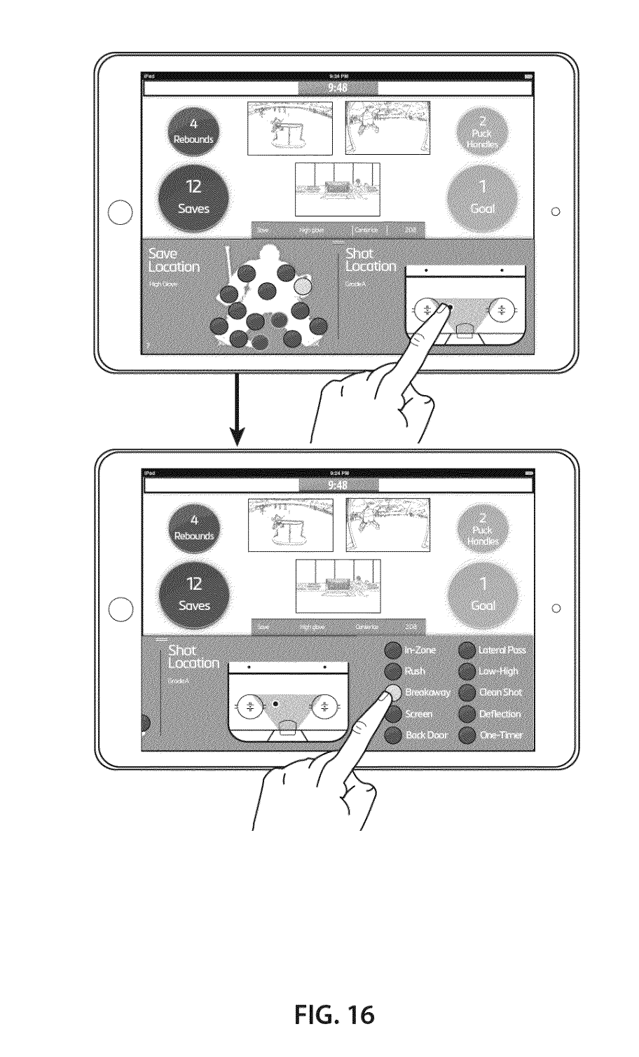

Alternatively, or additionally, the user interface of in FIG. 15 may provide touch-sensitive control areas to indicate the type of goaltending event directly, without automatic recognition using IMU or 3D Space sensor telemetry data. Touch-sensitive control areas Save, Rebound, Goal, and Puck Handling, as shown in FIG. 15, may display a cumulative total of tagged events of the type associated with each control area. The user indicates a goaltending event by touching one of the goaltending event control areas. The goaltending event is stored and the video timeline is tagged and captured as with gesture-based tagging. Additionally, user gestures may be received from the touch-input display interface by way of a silhouette of a goalie, as shown in FIG. 15. The silhouette provides touch-sensitive control areas at various points on the goaltender and/or goaltending equipment. The user indicates a location by touching the silhouette at the nearest point of contact to the goaltender or goaltender equipment.

Continuing from the identification of the gesture and subsequent tagging of video as above, video tagging apparatus presents a “shot chart” image of a hockey rink, and activates the touch-input device to receive user gestures in the area of the shot chart image. As shown by the example of FIG. 16, top, the user may indicate on the shot chart a shot location associated with a “Save” event by touching the shot chart at an approximate location to indicate where the shot was taken. Additionally, a shot trajectory may be indicated on the shot chart by a gesture indicating a shot location and a rebound location, or by a user indication of the path followed by the puck from the shot location to the net, and, for a rebound event, along a rebound trajectory. Shot chart location data is stored as metadata in the video tagging database along with the goaltending event identifier and time stamps and captured video data, as above, fully identifying and characterizing the goaltending event for later review of video of individual events, and for processing performance metrics and analytics of single and cumulative events.

In this manner, the IMU and processor repeat steps to acquire and tag multiple sequences during the game and the user can add specific identifiers post-game to each automatically tagged video sequence.

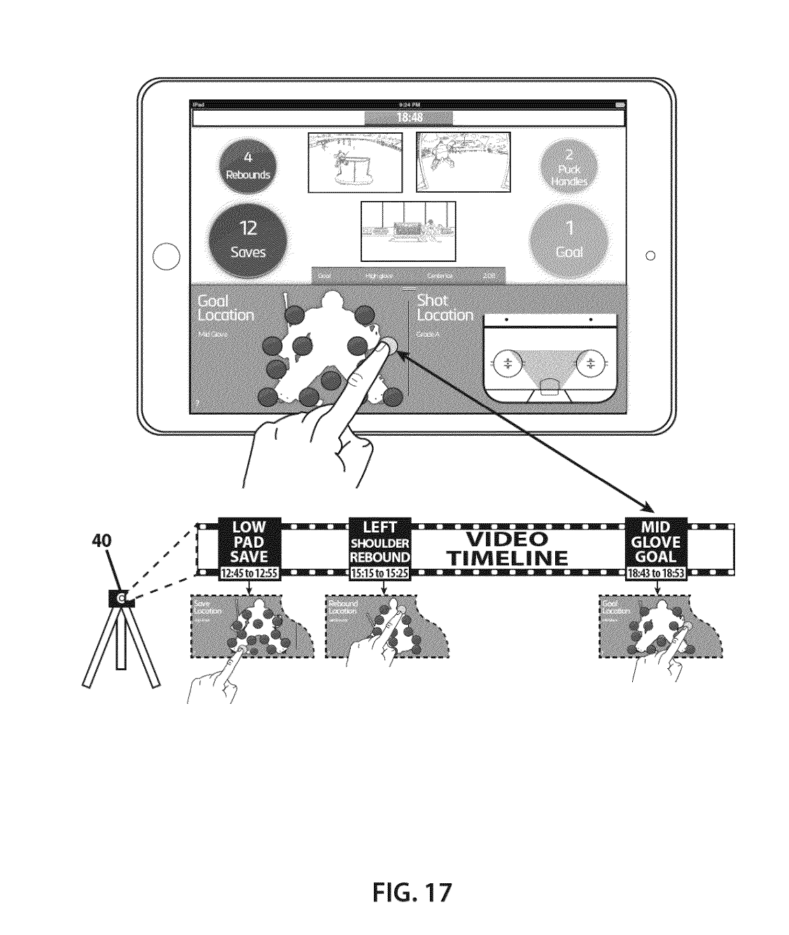

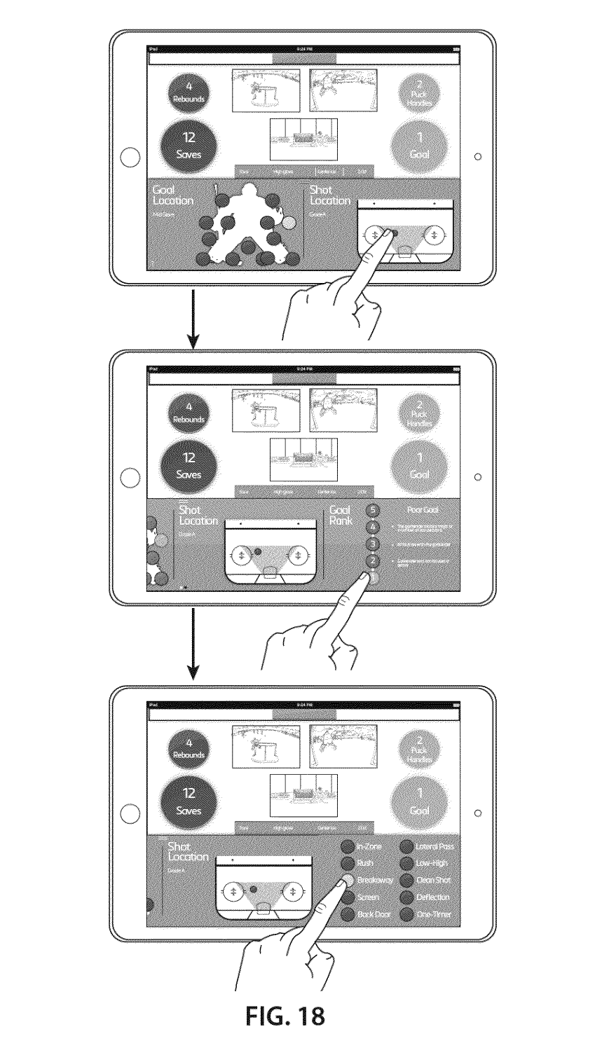

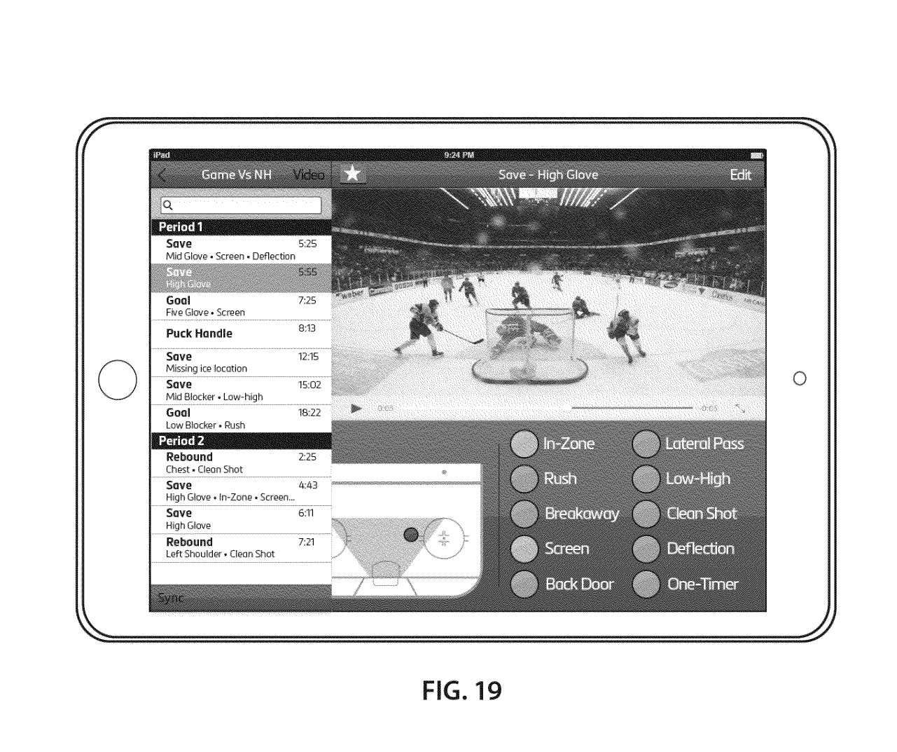

FIGS. 17 and 18 illustrates a method of video tagging using video tagging apparatus and system embodiments as described above. Automatic video tagging or sensor-based tagging may be used in combination for “Goal” events as well as “Save” events, the method and functions of the apparatus proceeding identically as with the automatic video tagging methods previously described. As shown in FIG. 18, gesture-based input for “Goals” includes receives user indications allowing a user to rank the goal according to a scale of 1 to 5, or alternatively, as “poor” “weak” “average” “good” or “no-chance.” Ranked goals, save percentage and goals against average are processed by the Performance Library into a summarized goal ranking of “G-RANK” stored as metadata along with tagged video of the goal event.

### Post-Game Review and Video Tagging

FIG. 19 illustrates a preferred method of accessing previously stored and/or tagged video of goaltending events according to an exemplary process using touch-input user interface(s) to review and edit previously or partially tagged video data, applicable to a variety of applications with various embodiments. The interface of FIG. 19 presents tagged video events as a selectable list of tagged video events stored by methods and system described above, to the Performance Library or other storage means. Goaltending events, e.g. Save, Goal, Puck Handle, and Rebound are displayed with metadata captured during video tagging,

As shown for the sport of ice hockey, tagged events are arranged by time period, although other arrangements and order of presentation as appropriate to ice hockey, or other goaltending sports may be used. Upon user selection of a goaltending event, the associated tagged video sequence is retrieved and displayed in the video area of the display, with corresponding video controls for play and display settings. As suggested by the “shot chart” in the lower half of FIG. 19, contextualized detail interfaces are provided and employ gesture-based interfaces as above for initial video tagging, for a user to enter missing information or to supplement metadata not collected during the game or previously performed video tagging session.

### Performance Library

The Performance Library System assembles, stores, organizes, retrieves and displays gesture tagged identifiers (saves, shots, goals, ice location and puck handling) data during games/season(s) in one location. The Performance Library may be stored locally in a local memory or accessed and retrieved from central storage (e.g. the cloud). In addition, and without limitation, such data may include games played, number of goals against, number of saves, number of shots, shut-outs, game record, save percentage and goals against average. This data provides the goaltender with important performance metrics in order to evaluate his or her athletic performance over the course of a game, season and career.

### Goals by Location

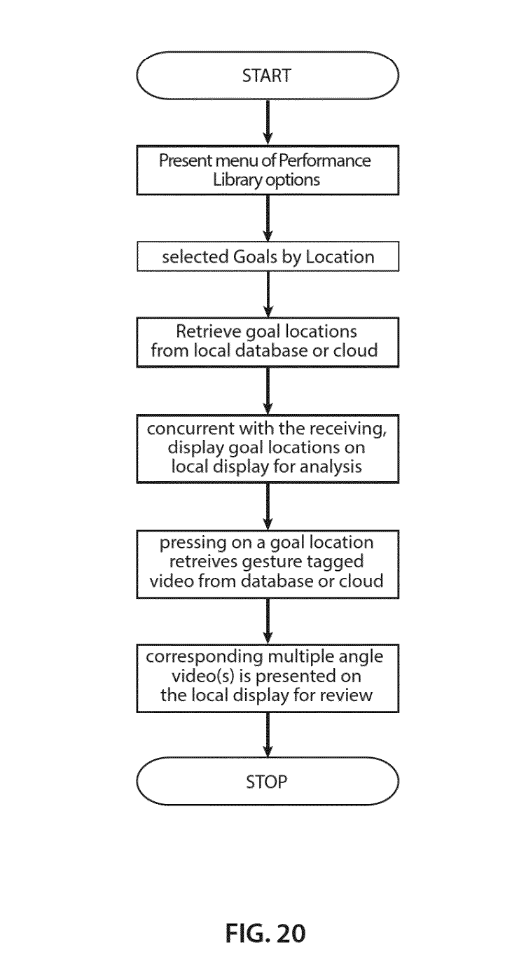

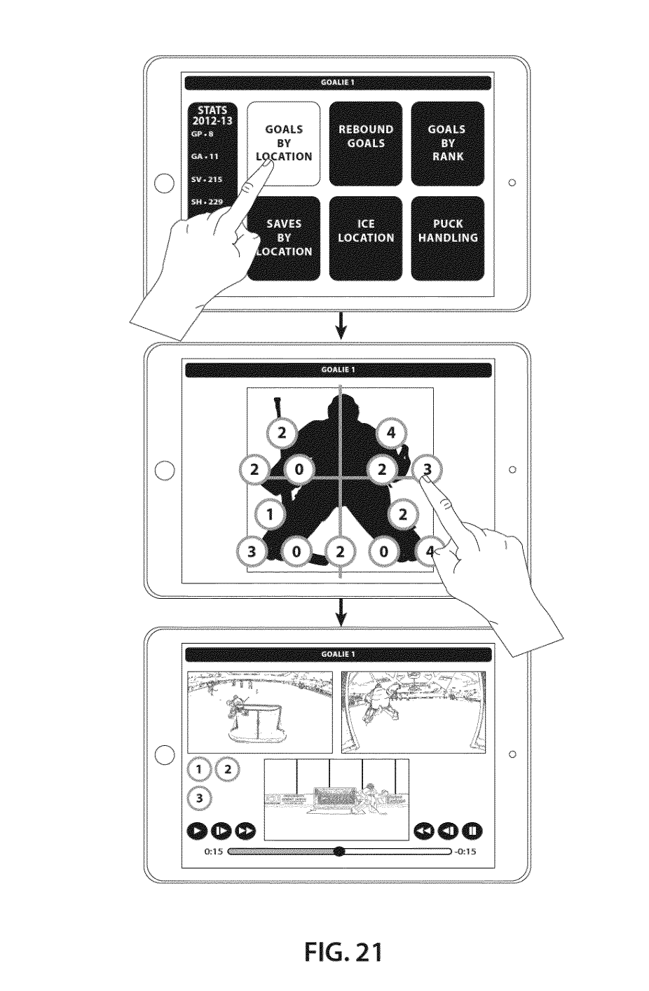

FIGS. 20 and 21 demonstrate a method and touch-sensitive user interface for retrieving Goals-by-location data from the Performance Library. Concurrent with the receiving and display of goal locations on the local display for analysis, pressing on a goal location retrieves gesture-tagged video of the corresponding multiple angle video for presentation on the local display.

### Saves by Location

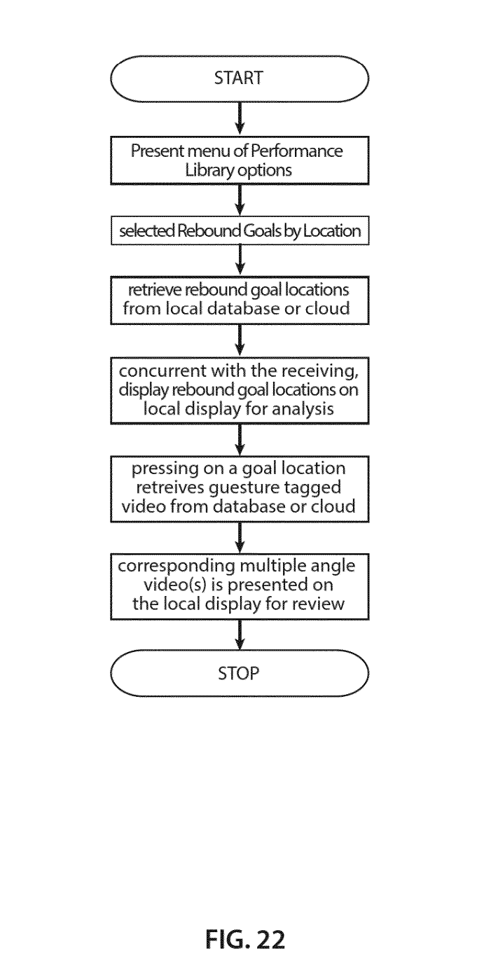

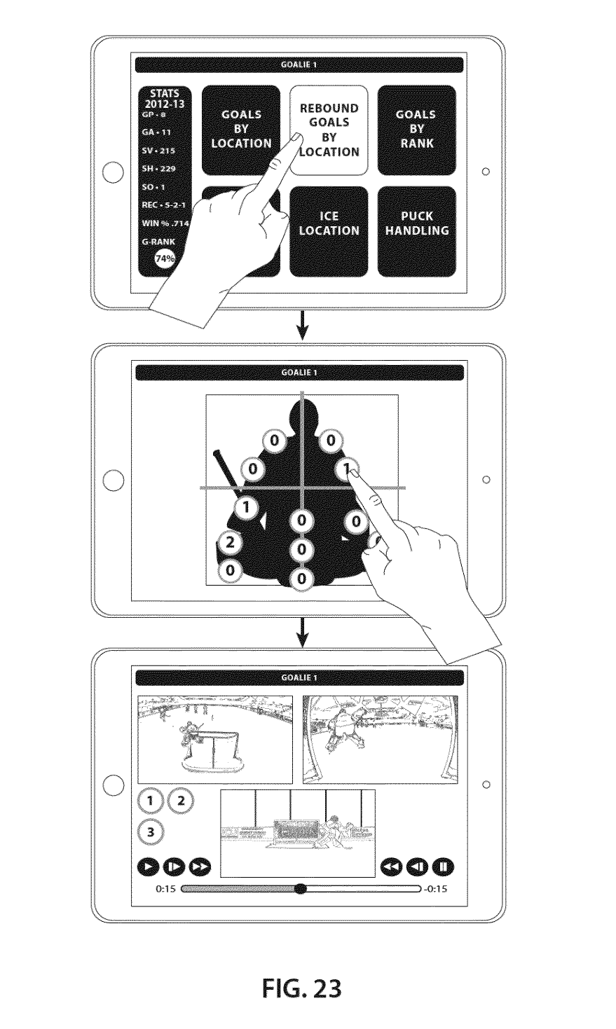

FIGS. 22 and 23 demonstrate a method and touch-sensitive user interface for retrieving Rebound-coals-by-location from the Performance Library. Concurrent with the receiving and display of rebound goal locations on local display, pressing on a goal location retrieves gesture-tagged video of the corresponding multiple angle video for presentation on the local display.

### Rebounds By Location

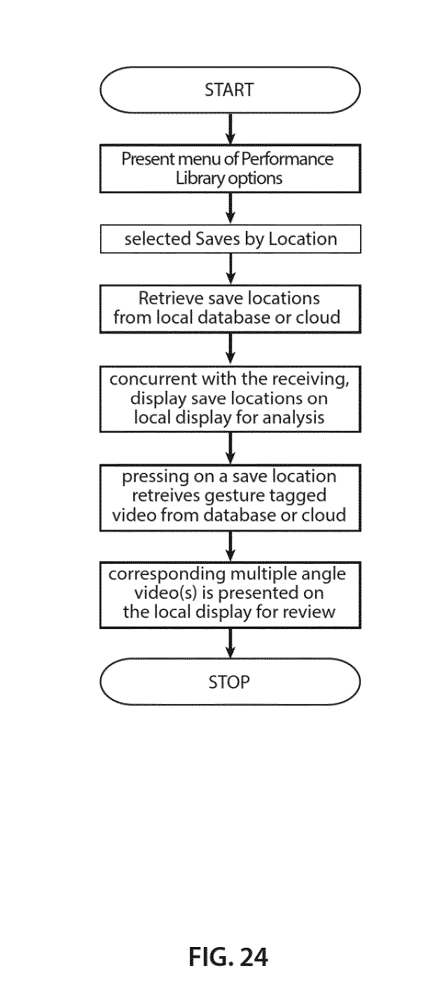

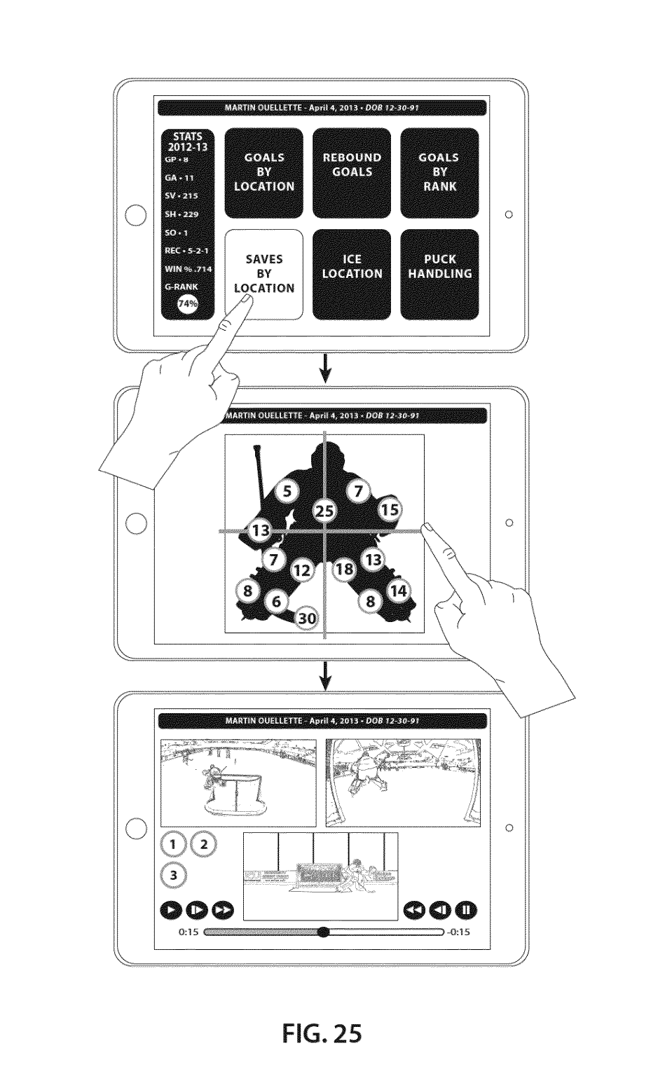

Similarly, FIGS. 24 and 25 demonstrate a method and touch-sensitive user interface for retrieving Saves-by-location from the Performance Library. Concurrent with the receiving and display of saves by location on local display, pressing on a goal location retrieves gesture-tagged video of the corresponding multiple angle video for presentation on the local display.

### Goals by Rank

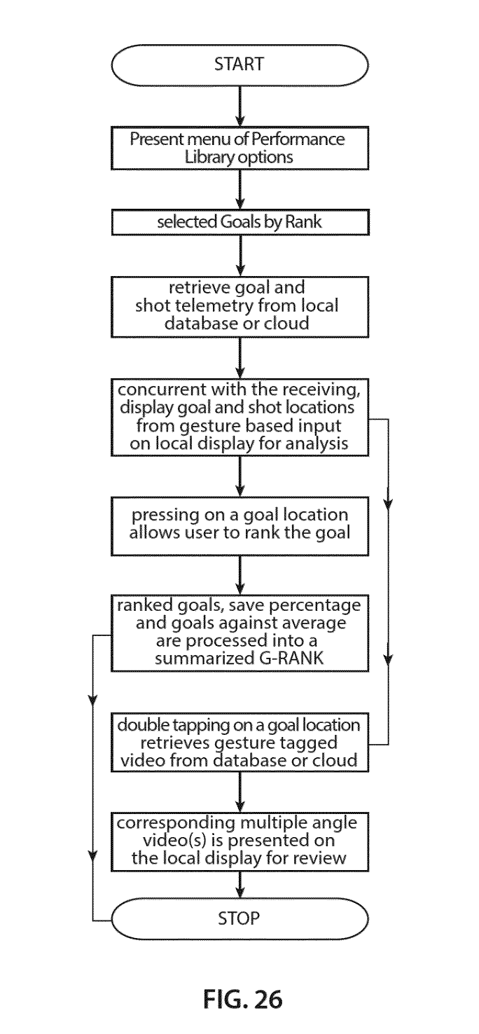

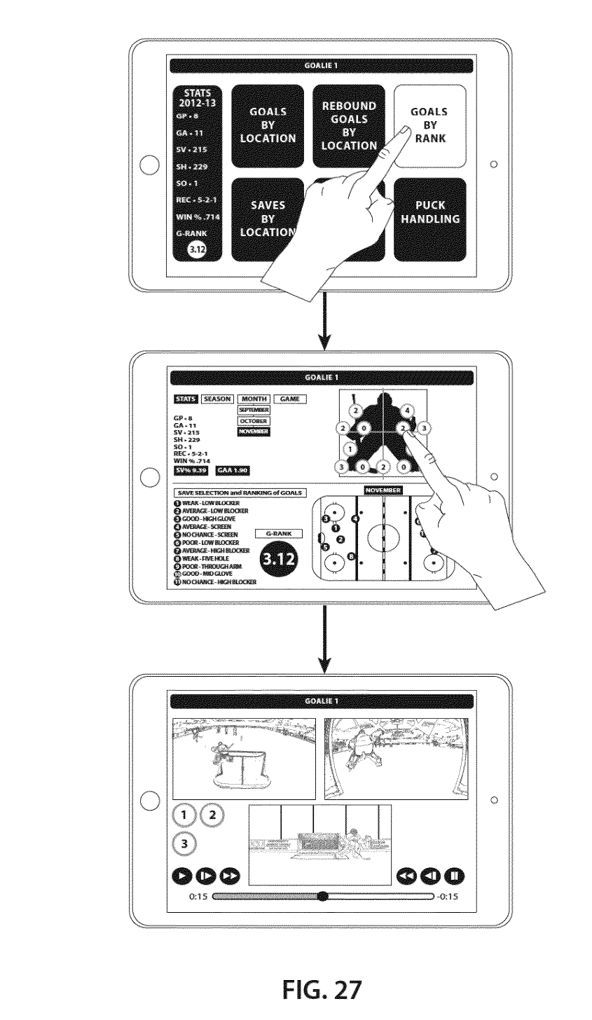

A further object in the application of the present invention to goaltending performance, in the sport of ice hockey, FIGS. 26 and 27 exemplifies aspects of the present invention by providing performance data on goals-by-rank. Goal-by-Rank of the Performance Library allows the user to assign a rank to each tagged goal. Goals are ranked by the degree of difficulty of the situation and position of the shot and the availability of defense and other circumstances of the shot on goal, on a scale of 1 to 5, from the most to the least difficult, correspondingly.

Upon receiving selection of “Goals by Rank,” goal and shot telemetry are received from local storage or cloud and displayed on the touch device. Ranked goals, save percentage and goals against average are processed and summarized into a “G-RANK” for display. In this manner. Lagged video data is enhanced to provide further comprehensive feedback and evaluation of goals against and to allow review of the corresponding multiple-angle video to be presented on the local display by double tapping on a goal location to cause the Performance Library system to retrieve gesture-tagged video from the Performance Library database.

### Tender Test

Success in goaltending requires proper execution of specific goaltending technique, the precise and practiced movement and positioning of the goaltender in the vicinity of the net and in reaction to shots on goal. Proper technique requires speed and precision in the movement and position of the goaltender's key extremities and associated protective equipment, namely, glove, blocker and skates, to maximize opportunity to block shots and for the goaltender to maintain optimal position at all times to react to ongoing play,

Accordingly, system and methods of the present invention provide for testing and scoring of goaltender technique, for improvement of goaltender performance in games and practices, using measurement of movement and position of goaltending equipment and by such measurement of movement and position generally about the goaltending environment. In one embodiment of the “Tender Test” system shown in FIG. 9 adapted to a typical goaltender test environment as depicted in FIGS. 1 and 2, inertial measurement unit (I mu) sensor modules 10 attached or embedded to goaltender equipment 2, and 3D Space sensors 30 as shown in FIGS. 1 and 3, provide precise measurement of movement and position of the goaltender. Specifically, telemetry metrics from IMU and 3D sensors provide, by measured and/or calculated metrics, the absolute and relative distances and positions of a goaltender's key extremities and associated equipment, namely, the glove, blocker and skates. As proper execution of a goaltender technique in different game and practice scenarios requires precise and practiced movement and positioning by the goaltender, such measurements provides means for determining whether the goaltender has executed a technique properly and a measure of his or her performance accuracy.

By example, proper execution of the Butterfly Save, a critical ice hockey goaltending technique, requires a goalie's feet to be a certain distance apart to maximize coverage of the net with the goalie pads. Too short a distance and the pads do not cover enough of the net too wide and the goaltender's limited mobility will not allow recovery to make another save. Proper butterfly save technique maximizes the goalie's opportunity to block shots and to maintain optimal position at all times to react to ongoing game play. A second example of critical goaltending technique is the Glove Projection. Glove projection is an important component of proper technique under many scenarios, and ensures that the goaltender is projecting his glove to optimally cut down the angle of the shot. Similarly, the technique of Blocker Projection may be measured and scored by the relative distance and positions of the blocker and corresponding foot as an indication and performance metric showing that the projection of the blocker is optimal. In a testing environment, it is also beneficial to replicate a game sequence of techniques emphasizing proper glove and blocker projection as the goaltender moves from one technique to another.

Accordingly, the goaltender Tender Test system shown in FIG. 9 uses movement and position data from IMU sensor modules 10 and 3D Space sensors 30 in communication with portable computing device 20 to test specific goaltender technique and provide feedback to the goaltender. The goaltender may perform specific skill tests according to his or her sport (e.g., ice hockey, field hockey, soccer or lacrosse) and will receive a summarized score through the collection of IMU and 3D space sensor data processed by the mobile or computer application. IMU and 3D Space sensor data is then algorithmically compared to stored performance data or idealized performance data. Upon completion of a goaltender skill test, or set or sequence of tests, the system calculates and displays his or her goaltender performance metrics and summarized test scores. Advantageously, the system compares, scores, and shares goaltender testing performance data with and against the performance data of peer, professional or virtual goaltenders using ideal theoretical skill data.

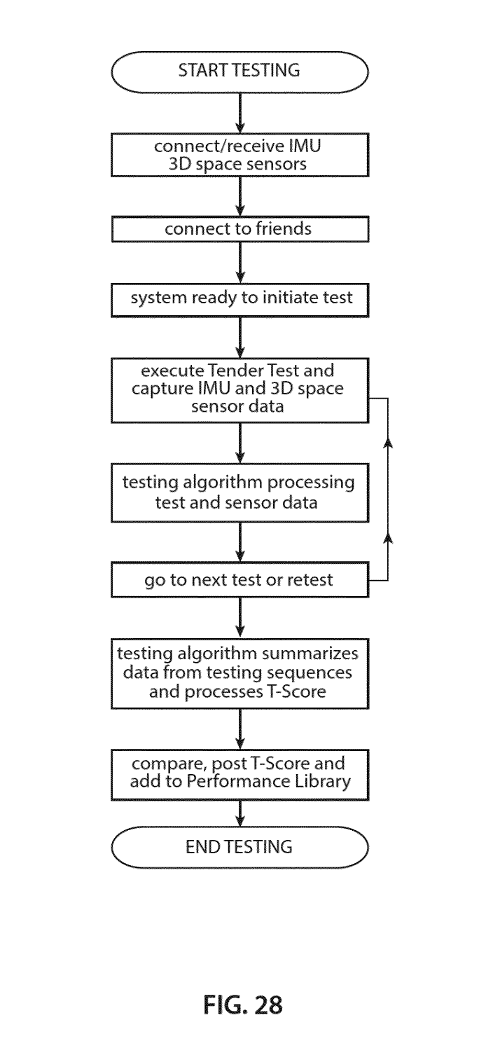

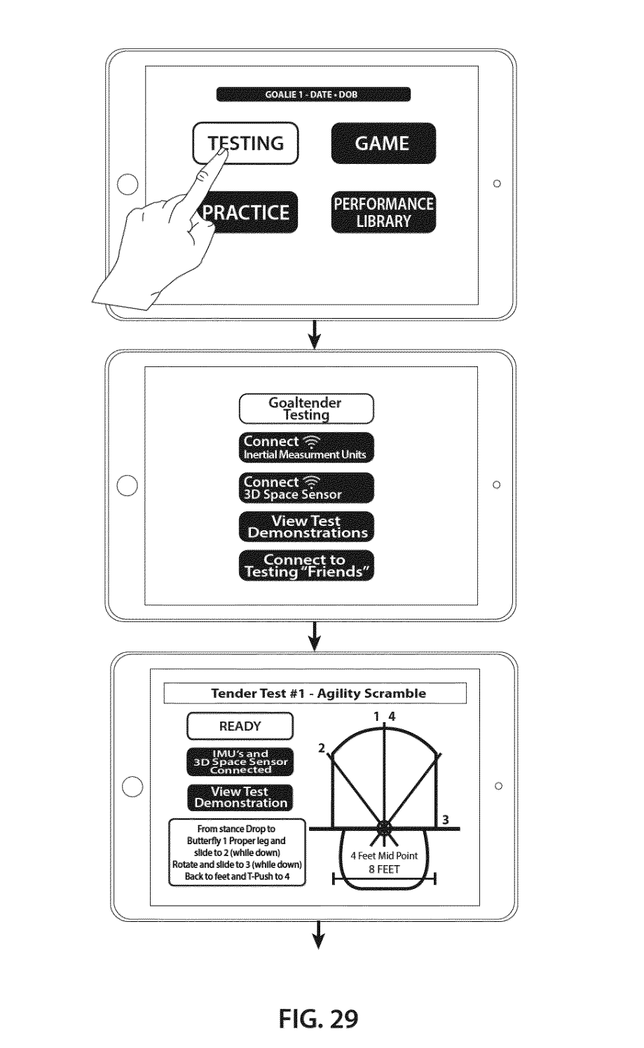

An exemplary method of goaltender testing according to the testing environment depicted in FIG. 1, in conjunction with the Tender Test apparatus of FIG. 9, is illustrated by the flowchart of FIG. 28 and the sequence of user interface interactions for performing Tender Tests in FIGS. 29-31.

With reference to FIG. 29, top, the user chooses a testing platform and the system provides the testing menu. The user may wirelessly connect to the IMU's and/or 3D space sensors to the application. The user may connect with “friends” who are also using the platform. It should be readily apparent that users of the inventive platform may be concurrent (i.e., live/real-time events) or based upon stored data previously occurring even(s). The user can view demonstrations of each test. The user proceeds to test number one, gets the description and prepares for the test.

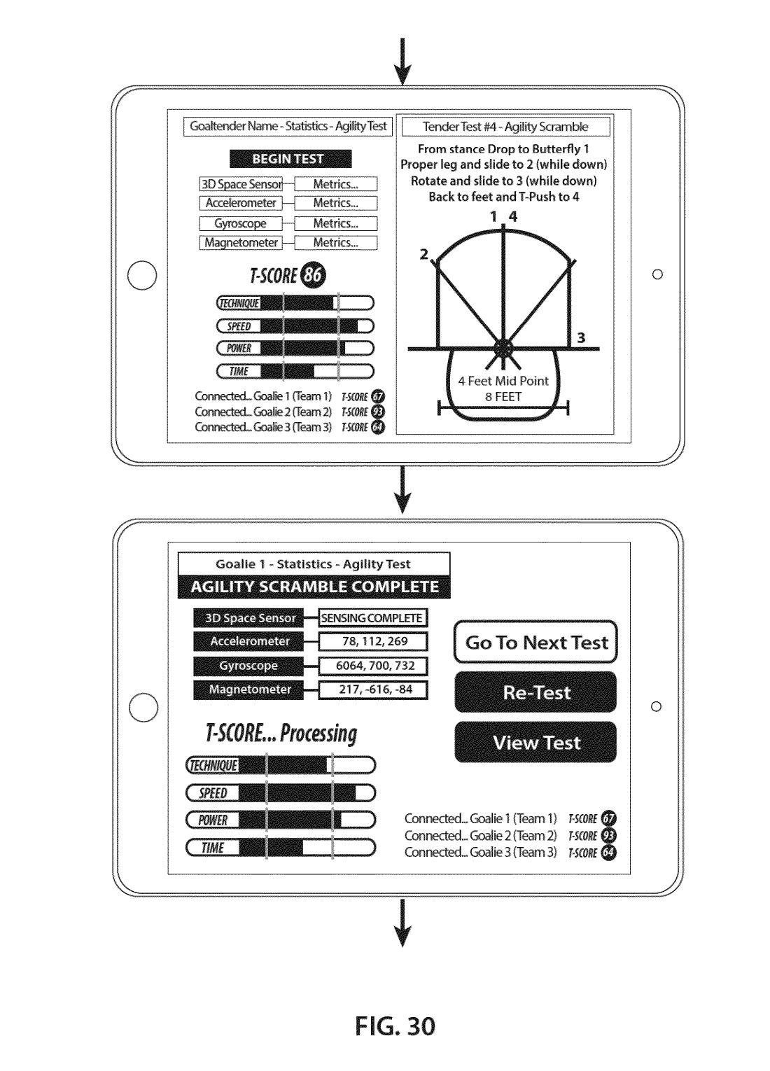

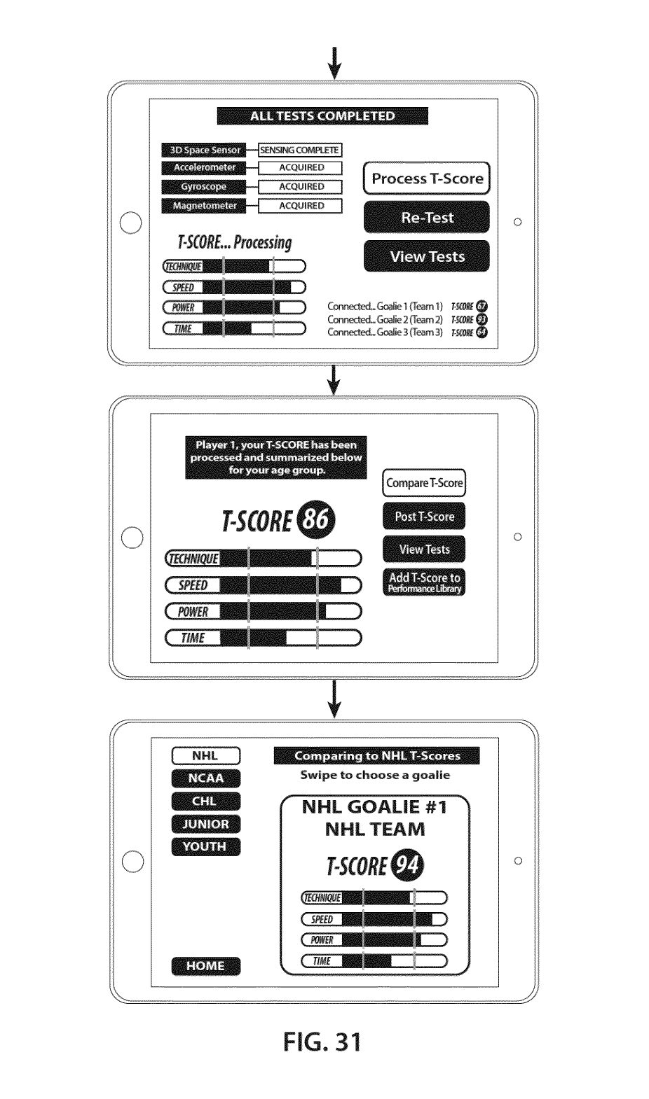

With reference to FIG. 30, the test begins and is executed by the goaltender in the vicinity of the net. During testing, the system receives, stores, and processes telemetry data from IMU sensors and 3D Space sensors, capturing acceleration, power, speed, rotation, body or body part position or orientation, or absolute and relative position, movement and distance of the goaltender during each test. User then continues to execute all of the tests until complete and the summarized performance score is processed.

As shown in FIG. 31, the user can post their summarized performance score to social media, send it to his or her Performance Library, and/or compare the score to others who have posted to the testing platform. The goaltender can then compare or share his or her summarized score via social media or with other users connected to the testing interface. Interconnectivity with one or more other users may be implemented in any suitable manner whereby, for example, social media (e.g. Facebook, Twitter, LinkedIn, Google Circles, etc.) which may be linked with a cloud-based repository of scores for comparisons with other stored scores. In this manner, a user may judge their own scores against earlier stored data and compiled scores related to peers, professional goaltenders, or even idealized theoretical data created from virtual goaltenders' performance metrics.

Skill specific goaltender testing for ice hockey, for example, includes “crease tests” or “agility tests,” the system directing the goalie to perform a sequence of maneuvers within the crease to test and evaluate goaltender agility. IMU sensor modules 10 attached to or embedded in the goaltender or goaltending equipment provide telemetry on acceleration, power, speed, rotation, body or body part position or orientation, or absolute and relative position, movement and distance. Alternatively or additionally, 3D Space sensors provide telemetry data on the position of the goaltender within the crease as the tests are conducted. Testing for ice hockey may also include “butterfly save,” “glove projection,” or “blocker projection” measurement, the testing system using IMU sensors attached to or embedded in glove, blocker and skates to measure such relative distance and positions, and by such measuring and analyzing, provide performance feedback on glove and blocker projection based on the relative positions of the hands and feet of the goaltender. The system may then analyze the sequence and automatically provides a metric to indicate the level of success in the technique of glove and blocker projection. Skill testing through technique measurement and scoring may be performed as isolated tests, or skills and techniques may be measured and scored as part of a test or sequence of tests, simulating game or live practice scenarios.

In summary, it should be understood that the present invention is implemented within software and/or hardware that provides inventive methods and apparatus for movement and position sensor data collection and analysis, inventive methods and apparatus for video tagging of goaltender movements, and inventive methods and apparatus for compiling and utilizing a performance library system of the data and video tagging.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing. In the context of this document, a computer readable storage medium may be any tangible medium that can contain, or store a program for use by or in connection with an instruction execution system, apparatus, or device.

A computer readable medium may also include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It is to be understood that the software for the computer systems of the present invention embodiments may be implemented in any desired computer language and could be developed by one of ordinary skill in the computer arts based on the functional descriptions contained in the specification and flow charts illustrated in the drawings. By way of example only, the software may be implemented in the C#, C++, Python, Java, or PHP programming languages. Further, any references herein of software performing various functions generally refer to computer systems or processors performing those functions under software control. The computer systems of the present invention embodiments may alternatively be implemented by any type of hardware and/or other processing circuitry. The various functions of the computer systems may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.).

Aspects of the present invention are described with reference to flowchart illustrations and/or block diagrams of methods, apparatus (systems) and computer program products according to embodiments of the invention. It is be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operation steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A processing system suitable for storing and/or executing program code may be implemented by any conventional or other computer or processing systems preferably equipped with a touch-sensitive display or monitor, a base (e.g., including the processor, memories and/or internal or external communications devices (e.g., modem, network cards, etc.) and optional input devices (e.g., a keyboard, mouse, mouse pad, pointer stick, or other input device). The system can include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the system to become coupled to other processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, apparatus, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may in fact be executed substantially concurrently, or the blocks may at times be executed in the reverse order, depending on the functionality involved. It is noted that each block of the block diagrams and/or flowchart illustration, and combinations of blocks in the block diagrams and/or flowchart illustration can be implemented by special purpose hardware-based systems that perform the specified functions or acts, or combinations of special purpose hardware and computer instructions.

The terminology used herein describes particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention is presented for purposes of illustration and description, but is not intended to be exhaustive or limited to the invention in the forms disclosed. Many modifications and variations will be apparent to those of ordinary skill in the art without departing from the scope and spirit of the invention. The embodiments were chosen and described to best explain the principles of the invention and the practical applications, and to enable others of ordinary skill in the art to understand the invention for various embodiments with various modifications as are suited to the particular use contemplated.

Communications devices and sensor devices and modules described herein, including for transmitting computer readable program instructions as above, may use any suitable wireless technology including Bluetooth, Wi-Fi, WPAN (Wireless Personal Area Network), UWB (Ultra Wideband), 4G LTE or other mobile cellular communications protocol, and alternatively or in addition, any suitable wired data communications technology, including Ethernet, USB, WAN, LAN, the Internet, an intranet, or the like.

The above-described embodiments of the present invention are intended to be examples only. Alterations, modifications and variations may be effected to the particular embodiments by those of skill in the art without departing from the scope of the invention, which is defined solely by the claims appended hereto.

1. An apparatus for processing goaltender performance data and metrics, said apparatus comprising:
one or more sensor devices arranged in the vicinity of a goal for measuring data selected from a telemetry metrics group including acceleration, power, speed, rotation, goaltender biometrics, body position, movement, and distance;
a computing device for processing said data to calculate performance metrics and summarized goaltender performance scores; and
at least one wireless communications device for transmitting and/or receiving said data at said computing device.

2. The apparatus of claim 1, wherein the one or more sensor devices includes at least one inertial measurement unit sensor module attached to or embedded in goaltender equipment in use by a goaltender positioned in the vicinity of the goal.

3. The apparatus of claim 2, wherein the at least one inertial measurement unit sensor module provides telemetry metrics based on sensing accelerometer, gyroscope, compass, or gravitational force data in three-directions.

4. The apparatus of claim 2 or 3, wherein the at least one inertial measurement unit sensor module provides telemetry metrics on relative position, movement or distance of the goaltender or goaltender equipment.

5. The apparatus of claim 1, wherein the one or more sensor devices includes at least one 3D Space sensor mounted on or integral to the goal or other structure in the vicinity of the goal.

6. The apparatus of claim 5, wherein the at least one 3D Space sensor provides telemetry metrics based on absolute or relative position, movement or distance of the goaltender within a defined region in the vicinity of the goal.

7. The apparatus of claim 1, wherein the computing device further comprises a touch-sensitive input device providing contextualized gestured-based graphical user interfaces for receiving user input during games, practices, and testing activities.

8. The apparatus of claim 1, wherein the computing device further comprises a touch-sensitive display device providing contextualized gestured-based graphical user interfaces for providing real-time, in game, and post-game output of performance data, metrics, and summarized performance scores.

9. The apparatus of claim 1, further comprising one or more video devices providing real-time or stored video data of goaltender activity in the vicinity of the goal.

10. The apparatus of claim 9, wherein the one or more video devices provides single or multiple-angle video data to the computing device for display of goaltender activity in the vicinity of the goal.

11. The apparatus of claim 10, wherein the computing device further provides contextualized gesture-based graphical user interfaces for identifying and characterizing a goaltending event or activity within the video data by tagging a discrete point in time or time segment of fixed or variable duration.

12. The apparatus of claim 11, wherein the identifying and characterizing a goaltending event or activity within the video data includes automatically identifying and characterizing a goaltending event or activity based on telemetry metrics from the one or more sensor devices.

13. The apparatus of claim 1, wherein the processing of the one or more sensor device telemetry data provides goaltender testing by receiving, processing, displaying, and comparing performance metrics selected from acceleration, power, speed, rotation, body position, movement, distance and technique.

14. The apparatus of claim 13, wherein the goaltender testing includes comparing goaltender testing performance metrics based on expert or idealized metrics, or by connecting and sharing goaltender performance metrics and summarized performance scores by social media.

15. The apparatus of claim 1, further comprising a Performance Library for receiving, storing and providing goaltender performance data, metrics, tagged video data, and summarized performance scores.

16. The apparatus of claim 15, wherein the Performance Library is data network accessible to local and remote users by contextualized gestured-based graphical user interfaces providing real-time, in game, or post-game display of Performance Library data, metrics, video data, and summarized performance scores.

17. A method for processing goaltender performance data and metrics using an apparatus comprising one or more sensor devices arranged in the vicinity of a goal, and a computing device for calculating performance metrics and summarized goaltender performance scores, the apparatus including at least one wireless communications device for transmitting and/or receiving data to said computing device, the method comprising:
measuring, at the one or more sensor devices, data selected from a telemetry metrics group including acceleration, power, speed, rotation, goaltender biometrics, body position, movement, and distance;
transmitting, wirelessly, from the one or more sensor devices, telemetry metrics on acceleration, power, speed, rotation, biometrics, body position, movement and distance;
receiving, at the computing devices, said telemetry metric; and
processing the received telemetry metrics to calculate performance metrics and summarized goaltender performance scores during a game, practice or goaltender testing activity.

18. The method of claim 17, wherein the measuring, at the one or more sensor devices, includes measuring data of at least one inertial measurement unit sensor module attached to or embedded in goaltender equipment in use by a goaltender positioned in the vicinity of the goal.

19. The method of claim 18, wherein the at least one inertial measurement unit sensor module provides telemetry data based on sensing accelerometer, gyroscope, compass, or gravitational force data in three-directions.

20. The method of claim 18, wherein the at least one inertial measurement unit sensor module provides telemetry on relative position, movement or distance of the goaltender or goaltender equipment.

21. The method of claim 17, wherein the one or more sensor devices includes at least one 3D Space sensor mounted on or integral to the goal or other structure in the vicinity of the goal.

22. The method of claim 21, wherein the at least one 3D Space sensor provides telemetry metrics based on absolute or relative position, movement or distance of the goaltender within a defined region in the vicinity of the goal.

23. The method of claim 17, wherein the computing device further comprises a touch-sensitive input device providing contextualized gestured-based graphical user interfaces for receiving user input during games, practices, and testing activities.

24. The method of claim 17, wherein the computing device further comprises a touch-sensitive display device providing contextualized gestured-based graphical user interfaces for providing real-time, in game, and post-game output of performance data, metrics, and summarized performance scores.

25. The method of claim 17, further comprising one or more video devices providing video data of goaltender activity in the vicinity of the goal.

26. The method of claim 25, wherein the one or more video devices provides single or multiple-angle video data to the computing device for display of goaltender activity in the vicinity of the goal.

27. The method of claim 26, wherein the computing device further provides contextualized gesture-based graphical user interfaces for identifying and characterizing a goaltending event or activity within the video data by tagging a discrete point in time or time segment of fixed or variable duration.

28. The method of claim 27, wherein the identifying and characterizing a goaltending event or activity within the video data includes automatically identifying and characterizing a goaltending event or activity based on telemetry metrics from the one or more sensor devices.

29. The method of claim 17, wherein the processing of the one or more sensor device telemetry data provides goaltender testing by receiving, processing, displaying, and comparing performance metrics selected from acceleration, power, speed, rotation, body position, movement, distance and technique.

30. The method of claim 29, wherein the goaltender testing includes comparing goaltender testing performance metrics based on expert or idealized metrics, or by connecting and sharing goaltender performance metrics and summarized performance scores by social media.

31. The method of claim 17, further comprising a Performance Library for receiving, storing and providing goaltender performance data, metrics, tagged video data, and summarized performance scores.

32. The method of claim 31, wherein the Performance Library is data network accessible to local and remote users by contextualized gestured-based graphical user interfaces providing real-time, in game, or post-game display of Performance Library data, metrics, video data, and summarized performance scores.

33. An apparatus for compiling and utilizing a Performance Library system of goaltending data, metrics, video data, and summarized performance scores, said apparatus comprising:
one or more sensor devices arranged in the vicinity of a goal for measuring telemetry data selected from a telemetry metrics group including acceleration, power, speed, rotation, goaltender body position, movement, and distance;
a computing device for processing said telemetry data to calculate performance metrics and summarized performance scores;
a wireless transmitter for transmitting said telemetry data wirelessly to said computing device;
one or more video devices arranged in the vicinity of a goal for capturing video data selected from discrete movements of a goaltender;
a computing device for associating said video data with said movements by way of a gesture-based tagging scheme to form tagged data streams; and
a data storage device for storing said tagged data streams, said performance metrics, and said summarized performances scores in a performance library for subsequent retrieval.

34. A method for compiling and utilizing a Performance Library system of goaltending data, metrics, video data, and summarized performance scores, said method comprising:
measuring telemetry data selected from a telemetry metrics group including acceleration, power, speed, rotation, goaltender body position, movement, and distance;
transmitting said telemetry data wirelessly to a computing device;
receiving said telemetry data at said computing device;
processing said telemetry data to calculate performance metrics and output summarized performance scores;
capturing video data selected from discrete movements of a goaltender;
associating said video data with said discrete movements by way of a gesture-based tagging scheme to form tagged data streams; and
storing said tagged data streams, said performance metrics, and said summarized performance scores in a performance library for subsequent retrieval.
